(19) United States
(12) Patent Application Publication
(10) Pub. No.: US 2026/0233796 A1
(43) Pub. Date: Aug. 13, 2026

(54) e-Trailer with Solar Modules

(71) Applicant: Solaredge Technologies Ltd., Herzeliya (IL)

(72) Inventors: David Ben-Bassat, Ganey Tikva (IL); Laurent Lu, Erlangen (DE); Philipp Walther, Schweinfurt (DE); Roberto Chiacchiera, Perugia (IT); Ruben Petroni, Città di Castello (IT); Radenko Prnja, Vienna (AT)

(21) Appl. No.: 19/333,629

(22) Filed: Sep. 19, 2025

Related U.S. Application Data
(63) Continuation-in-part of application No. 19/211,737, filed on May 19, 2025.
(60) Provisional application No. 63/649,593, filed on May 20, 2024.
(60) Provisional application No. 63/652,772, filed on May 29, 2024.

(51) Int. Cl. B62D 63/08; B60L 1/00; B60L 8/00; B62D 63/02

(52) U.S. Cl. CPC B62D 63/08; B60L 1/00; B60L 8/003; B62D 63/025; B60L 2200/28

(57) ABSTRACT

Configured sections (e.g., modules) for a configurable (e.g., modular) trailer may comprise batteries, controllers, power and/or communication hubs and may be configured to provide and/or receive electrical power, communication and/or control of the configured sections (e.g., modules), and/or heat transfer capabilities to a configurable (e.g., modular) trailer and/or externally connected devices. A configurable (e.g., modular) trailer may comprise one or more configured sections (e.g., modules) that may be connected in series via electrical power connectors, communication connectors, and/or fluid connectors. The configurable (e.g., modular) trailer may also comprise ancillary equipment that may be electrically, communicatively, and/or mechanically connected to a configured section (e.g., module).

### CROSS REFERENCE TO RELATED APPLICATIONS

This patent application claims priority to and is a continuation-in-part of U.S. application Ser. No. 19/211,737, filed May 19, 2025, and also claims the benefit of U.S. Provisional Patent Application No. 63/652,772, filed May 29, 2024, entitled “Methods For Attaching a Photovoltaic Panel to a Surface,” and U.S. Provisional Patent Application No. 63/649,593, filed May 20, 2024, entitled “Modular Trailer.” The disclosures of U.S. Provisional Patent Application No. 63/652,772, and U.S. Provisional Patent Application No. 63/649,593, are hereby incorporated by reference in their entirety.

### BACKGROUND

Trailers are tools that are used frequently. Trailers may be used to transport items. Trailers may be used to transport portable spaces to work, sleep, prepare food, and/or shelter. The capabilities of trailers may be enhanced with the inclusion of modern electronics, battery technologies, and/or power distribution methods.

### SUMMARY

The following presents a simplified summary of various concepts disclosed herein. This summary is not an extensive overview and is not intended to identify key or critical elements or to delineate the scope of the claims. This summary is not intended to limit or constrain the present disclosure.

Systems, methods, and apparatus are described for a configurable (e.g., modular) trailer, and configured sections (e.g., modules) that may comprise a configurable (e.g., modular) trailer. The systems, methods, and apparatus as described herein may refer to one or more configured sections (e.g., modules) that may be electrically and communicatively connected and configurable (e.g., modular) trailer comprising one or more modules.

Each configured section (e.g., module) may be configured with multiple power distribution schemes including different input and/or output connectors, different voltage levels, and/or different current standards. Each configured section (e.g., module) may have an internal communication bus that may communicate with and/or control internal components of the configured section (e.g., module). Each configured section (e.g., module) may be configured with one or more wireless and/or wired communication methods that may share data with devices that may be communicatively connected using one or more wired and/or wireless standards. Also, or alternatively, a first configured section (e.g., module) may provide a common communication hub that may share data of all communicatively connected configured sections (e.g., modules) using one or more wired and/or wireless standards.

The configured sections (e.g., modules) may be housed in a plurality of different housings. The different housings may be rated to different standards (e.g., International Electrotechnical Commission (IEC) number 60529). The configured sections (e.g., modules) may comprise batteries, inverters, traction controllers, step up and/or step down transformers, power and/or communication connectors, etc. The batteries, inverters, traction controllers, step up and/or step down transformers, power and/or communication connectors, etc. may be configured for different ratings. Power hubs and/or power communication connectors, for example, may be configured for alternating current (AC) or direct current (DC), for different voltage and/or current values, and/or different current.

Configured sections (e.g., modules) may be configured to receive AC and/or DC power from external sources. The external sources may charge batteries contained in one or more configured sections (e.g., modules). External sources may comprise an external generator (e.g., a generator driving by an external internal combustion engine (ICE)), external solar panels, and/or a local power grid. The external sources may provide power to external sinks drawing power from a configured section (e.g., module). External power sinks may comprise external batteries (e.g., the battery of an electric vehicle (EV)).

A configurable (e.g., modular) trailer may be configured to house one or more configured sections (e.g., modules). The system of configured sections (e.g., modules) may be arranged for space consideration and/or to optimize functionality. Electrical systems of the configurable (e.g., modular) trailer may be configured to receive and/or distribute power from one or more configured sections (e.g., modules).

### BRIEF DESCRIPTION OF THE DRAWINGS

The present disclosure is illustrated by way of example and is not limited in the accompanying figures in which like reference numerals indicate similar elements and in which:

FIGS. 1, 2, 3, 4, and 5 show examples of mechanical and electrical diagrams of configured sections (e.g., modules) of configurable (e.g., modular) trailers.

FIG. 6 shows an example block diagram of a configurable (e.g., modular) trailer comprising a battery pack, a first power configured section (e.g., module), a second power configured section (e.g., module), a traction control configured section (e.g., module), and an ancillary device.

FIGS. 7A, 7B, 7C, 7D, 7E, 7F, 8A, 8B, 9, 10A and 10B show examples of configurable (e.g., modular) trailers.

FIGS. 11A, 11B, 11C, 11D, 11E, 11F, 11G, 11H, 11I, 11J, 11K and FIGS. 12A, 12B, 12C, 12D, 12E, 12F show examples of components of a configurable (e.g., modular) trailer.

FIGS. 13, 14, and 15 show example electrical diagrams of a configurable (e.g., modular) trailer.

FIGS. 16, 17, 18, and 19 show example power layouts and buses of a configurable (e.g., modular) trailer.

FIGS. 20A and 20B show an example of electrical, fluid, and mechanical connections of a configurable (e.g., modular) trailer.

FIG. 21 shows an example of a motor and associated components of a configurable (e.g., modular) trailer.

FIG. 22 shows an example of a battery and associated components of a configurable (e.g., modular) trailer.

### DETAILED DESCRIPTION

In the following description, reference is made to the accompanying drawings, which form a part hereof, and in which are shown, by way of illustration, various examples of the disclosure. It is to be understood that the examples shown and/or described are non-exclusive, and other examples may be practiced, and structural and functional modifications may be made without departing from the scope of the present disclosure.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Trailers are an important methods for transporting items. By incorporating modern communication methods, batteries, and/or power distribution platforms, trailers may be made that further the capabilities of the trailer. By designing a common housing to comprise different communication methods, different battery capabilities, and/or power distribution platforms, for different functions, an independently operable unit that is part of a total structure (e.g., a module) may be combined with other configured sections (e.g., modules) of a trailer so that the trailer may be configured to provide different and specific capabilities for the trailer. A trailer may be configured with one or more configured sections (e.g., modules) that may be interconnected, and trailers may be configured for different uses. Disclosed are configured sections (e.g., modules) that may be configured with different energy storage units, different power management methods, different cooling and/or heat exchange devices, electric motor interfaces, electric motor inverter interfaces, and trailers that may be configured with one or more configured sections (e.g., modules) and/or ancillary devices. Each configured section (e.g., module) of the trailer may include an interface component integrated into the configured section (e.g., module) and/or connectors that may be integrated into a configured section (e.g., module) housing. The interface component may include upstream and/or downstream connectors, fuses, contactors, controllers, and/or sensors. The connectors may include high voltage power connectors, low voltage power connectors, communication connectors, test connectors, and/or sensors connectors. The sensors may be incorporated into an interface component, located external to the configured section (e.g., module) and/or connected to the interface component using a connector. The interface components allow the output of one configured section (e.g., module) to connected to the input of a second configured section (e.g., module) forming a daisy chain using connectors and allow configurable (e.g., modular) trailers to be designed and built with complex architectures and/or for a variety of functions.

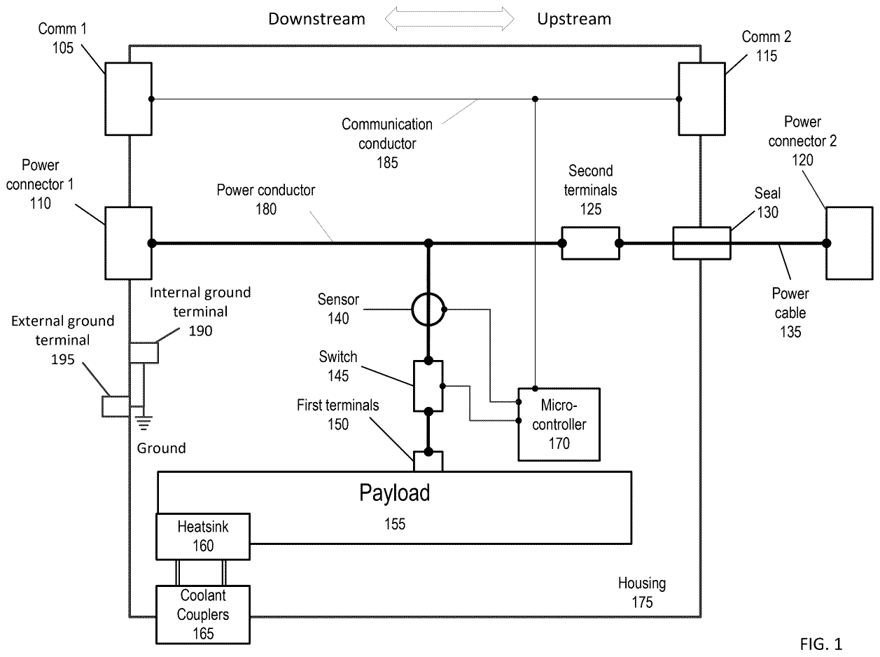

FIGS. 1-5 show examples of mechanical and electrical diagrams of various configured sections (e.g., modules) of a configurable (e.g., modular) trailer. FIG. 1 shows an example of a configured section (e.g., module) of a configurable (e.g., modular) trailer comprising a payload. A payload may comprise a heat exchanger, a battery, a power supply, a traction inverter, an inverter, a communication hub, etc. The configured section (e.g., module) of FIG. 1 comprises a housing 175. The housing 175 may be ingress protection rated. The ingress protection rating may be based on a determination of the ingress protection needed. A configured section (e.g., module) housing may be rated to be water tight, for example, if the configurable (e.g., modular) trailer is configured to transport a boat or if the configurable (e.g., modular) trailer is configured to provide a living space in wet regions. A configured section (e.g., module) housing may be rated for dust and/or fine particulate protection, for example, if the configurable (e.g., modular) trailer is configured to be used in a sandy and/or dusty region. The housing 175 may be vehicle certified using International Electrotechnical Commission (IEC) number 60529 to solids ingress protection (IP) rating of 6 and/or a liquids IP rating of at least 5. The housing 175 may comprise a number of connections (e.g., power connectors, communication connectors, mechanical connectors, etc.) and/or couplings. The housing may comprise a plurality of internal and/or external mounting and/or fixing points. A power supply supplies electric power to an electric load.

The power connectors may comprise an upstream power connector 120 (e.g., power connector 2) and/or a downstream power connector 110 (e.g., power connector 1). The upstream power connector 120 (e.g., power connector 2) and/or downstream power connector 110 (e.g., power connector 1) may be a part of a power cable 135. The power cable 135 may pass through a power seal 130 (e.g., seal 130) that may be integrated into the housing 175. A power conducting circuit 180 (e.g., power conductor) may comprise, and electrically connect, the upstream power connector 120 (e.g., power connector 2), downstream power connector 110 (e.g., power connector 1), and/or a switch 145. The switch 145 may be used to electrically connect, and provide electrical power, to one or more power circuit nodes (e.g., first terminals 150). The power conductor 180 may comprise one or more additional terminals (e.g., second terminals 125) that may be used to provide connection points to the power conductor 180.

A power conductor 180 may comprise a plurality of ends (e.g., power circuit nodes) that may comprise power connectors (e.g., power connector 1 110, power connector 2 120, etc.). The power connectors (e.g., power connector 1 110, power connector 2 120, etc.) may comprise standard power connectors (e.g., single-pin high-voltage connectors, multi-pin high-voltage connectors, high-voltage connectors for extreme environments, etc.). The power connectors (e.g., power connector 1 110, power connector 2 120, etc.) may comprise an electric vehicle (EV) charging plug. The configured section (e.g., module) of a configurable (e.g., modular) trailer may be powered by an EV charging station and/or charge an EV, for example, if one or more power connectors are an EV charging plug. The power conductor may comprise an upstream power connector 120 (e.g., power connector 2) and/or a downstream power connector 110 (e.g., power connector 1). One or more of the power connectors (e.g., power connector 1 110, power connector 2 120, etc.) may be a solar power connector. The solar power connector may be integrated into a housing 175 of a configured section (e.g., module) of a configurable (e.g., modular) trailer. A housing 175 of a configured section (e.g., module) of a configurable (e.g., modular) trailer may comprise a ground terminal and/or ground socket. The ground terminal and/or ground socket may be electrically connected to the exterior of the housing 175. The ground terminal and/or ground socket may be connected to the interior of the housing 175. The configured section may comprise a socket for EV charging. The socket may comprise a 60 VDC+ automotive connector.

The upstream power connector 120 (e.g., power connector 2) and/or downstream power connector 110 (e.g., power connector 1) may be integrated into the housing. The upstream power connector 120 (e.g., power connector 2) and/or downstream power connector 110 (e.g., power connector 1) may be configured to be connected to an external power cable. The upstream power connector 120 (e.g., power connector 2) and/or downstream power connector 110 (e.g., power connector 1) may comprise an external power cable (e.g., power cable 135). The upstream power connector 120 (e.g., power connector 2) and/or downstream power connector 110 (e.g., power connector 1) may be configured to couple with an electric vehicle charging plug. A configured section (e.g., module) of a configurable (e.g., modular) trailer may comprise a plurality of electrical busses comprising one or more direct current (DC) voltages and/or alternating current (AC) voltages and/or frequencies. The configured section (e.g., module) of a configurable (e.g., modular) trailer may comprise one or more low voltage DC lines, buses, and/or sources and/or one or more high voltage DC lines, buses, and/or sources. Voltages for the one or more low voltage DC lines may consist of standard low voltage DC lines, sources, and/or buses (e.g., 5 VDC, 12 VDC, 15 VDC, 24 VDC, 28 VDC, and 48 VDC) and/or custom (e.g., variable) low voltage DC levels between 5 VDC and 48 VDC. The configured section (e.g., module) of a configurable (e.g., modular) trailer may comprise one or more DC voltage lines and/or buses that may have DC voltages greater than 48 VDC. The configured section (e.g., module) of a configurable (e.g., modular) trailer may comprise high voltage DC lines buses for voltages between 48 VDC and 2000 VDC. The configured section (e.g., module) of a configurable (e.g., modular) trailer may comprise one or more DC voltage lines and/or buses that may have DC voltages between 100 and 240 VDC, 400 VDC, and/or 800 VDC. The configured section (e.g., module) of a configurable (e.g., modular) trailer may comprise one or more DC voltage lines and/or buses that may be variable and/or configurable. A high voltage DC line and/or bus may be configurable for DC voltages greater than 100 VDC.

A housing 175 of a configured section (e.g., module) of a configurable (e.g., modular) trailer may comprise one or more integrated high voltage power sockets and/or one or more integrated low voltage power sockets. A housing 175 of a configured section (e.g., module) of a configurable (e.g., modular) trailer may comprise a low voltage power socket for one or more of one or more low voltage DC lines and/or buses. The configured section (e.g., module) of a configurable (e.g., modular) trailer may comprise an integrated 5 VDC low voltage power socket that may be electrically connected to a 5 VDC electrical bus, for example, if the configured section (e.g., module) of a configurable (e.g., modular) trailer comprises a 5 VDC low voltage bus and the configured section (e.g., module) of a configurable (e.g., modular) trailer is configured to provide an external 5 VDC power supply. The housing 175 of the configured section (e.g., module) of a configurable (e.g., modular) trailer may comprise a 12 VDC power socket, for example, if the configured section (e.g., module) of a configurable (e.g., modular) trailer comprises a 12 VDC low voltage bus and the configured section (e.g., module) of a configurable (e.g., modular) trailer is configured to provide an external 12 VDC power supply. The housing 175 of the configured section (e.g., module) of a configurable (e.g., modular) trailer may comprise a plurality of integrated test sockets for testing the electrical busses. The configured section (e.g., module) of a configurable (e.g., modular) trailer may comprise an integrated test socket for testing a 5 VDC bus, for example, if the configured section (e.g., module) of a configurable (e.g., modular) trailer provides 5 VDC power. The configured section (e.g., module) of a configurable (e.g., modular) trailer may comprise an integrated test socket for testing a 12 VDC bus, for example, if the configured section (e.g., module) of a configurable (e.g., modular) trailer provides 12 VDC power. For maintenance, a test allows insulation, communication, status, voltages, HVIL, etc. to be checked.

The one or more high voltage power sockets that may be integrated in the housing 175 of a configured section (e.g., module) of a configurable (e.g., modular) trailer may comprise one or more sockets for each high voltage line and/or bus. The housing 175 of a configured section (e.g., module) of a configurable (e.g., modular) trailer may comprise one or more integrated 400 VDC high voltage power sockets electrically connected to a single 400 VDC high voltage line and/or bus. The housing 175 of a configured section (e.g., module) of a configurable (e.g., modular) trailer may comprise one or more integrated 400 VDC high voltage power sockets electrically connected to each of one or more 400 VDC high voltage lines and/or buses. The configured section (e.g., module) of a configurable (e.g., modular) trailer may have multiple high voltage DC lines and/or buses of the same DC voltage. The configured section (e.g., module) of a configurable (e.g., modular) trailer may have multiple high voltage DC lines and/or buses, for example, if the power needs of a single high voltage line and/or bus is inadequate. The configured section (e.g., module) of a configurable (e.g., modular) trailer may have multiple high voltage DC lines and/or buses, for example, if the excessive noise may be present and/or expected on a high voltage DC line and/or bus. An integrated high voltage auxiliary power socket may be configured for voltages between 48 VDC and 2000 VDC. An integrated high voltage auxiliary power socket may be configured for voltage ratings of 100-240 VDC, 400 VDC, and/or 800 VDC. An integrated high voltage auxiliary power socket may be configured for a voltage rating of greater than 100 VDC.

An integrated high voltage power socket may be configured to connect to external auxiliary devices. An integrated high voltage power socket may be configured to connect to an external heater and/or air conditioner, for example, if the configured section (e.g., module) of a configurable (e.g., modular) trailer is configured to provide external power to the heater and/or air conditioner. An external heater and/or air conditioner may be the heater and/or air conditioner of a vehicle (e.g., an EV).

One or more power circuit nodes (e.g., first terminals 150) may provide connections to one or more devices (e.g., payload 155). The one or more device (e.g., the payload 155) may be electrically, mechanically, and/or thermally connected to additional devices. The payload 155 may be thermally connected to a heat exchanger (e.g., heatsink 160), for example, to provide cooling and/or heating of the payload using an external cooling and/or heating device. The cooling and/or heating may be moderated by fluid flow. The fluid flow may be supplied to the heat exchanger (e.g., heatsink 160) via coolant couplers 165 (e.g., fittings) passing through or alternatively physically attached to the housing 175. The coolant couplers 165 (e.g., fittings) may be integrated into the housing 175.

A communication conductor 185 may electrically connect a plurality of communication circuit nodes. The circuit nodes of the communication conductor 185 may comprise an upstream communication connector 115 (e.g., comm 2), a downstream communication connector 105 (e.g., comm 1), and/or a microcontroller 170. The microcontroller 170 may control the communication circuit nodes. The communication nodes may comprise communication terminals. A communication conductor may comprise a first communication connector 105 (e.g., comm 1) and/or a second communication connector 115 (e.g., comm 2). The first communication connector 105 (e.g., comm 1) and/or the second communication connector 115 (e.g., comm 2) may be integrated with a housing 175 of a configured section (e.g., module) of a configurable (e.g., modular) trailer. The communication conductor 185 may comprise a communication cable. The communication cable may comprise an external communication cable. The communication may pass through a communication cable seal integrated with the housing 175 of the configured section (e.g., module) of a configurable (e.g., modular) trailer. The first communication connector 105 (e.g., comm 1) and/or the second communication connector 115 (e.g., comm 2) may be connected to the end of the external communication cable.

A microcontroller 170 may be electrically connected to a sensor 140. The sensor 140 may be coupled between a power conductor 180 electrically connecting an upstream power connector 120 (e.g., power connector 2) to a downstream power connector 110 (e.g., power connector 1) and a switch 145. The sensor 140 may comprise one or more of a current sensor, a voltage sensor, a power sensor, etc. An external ground terminal 195 and/or an internal ground terminal 190 may be electrically connected to the housing 175 and/or to each other to provide a common ground for the

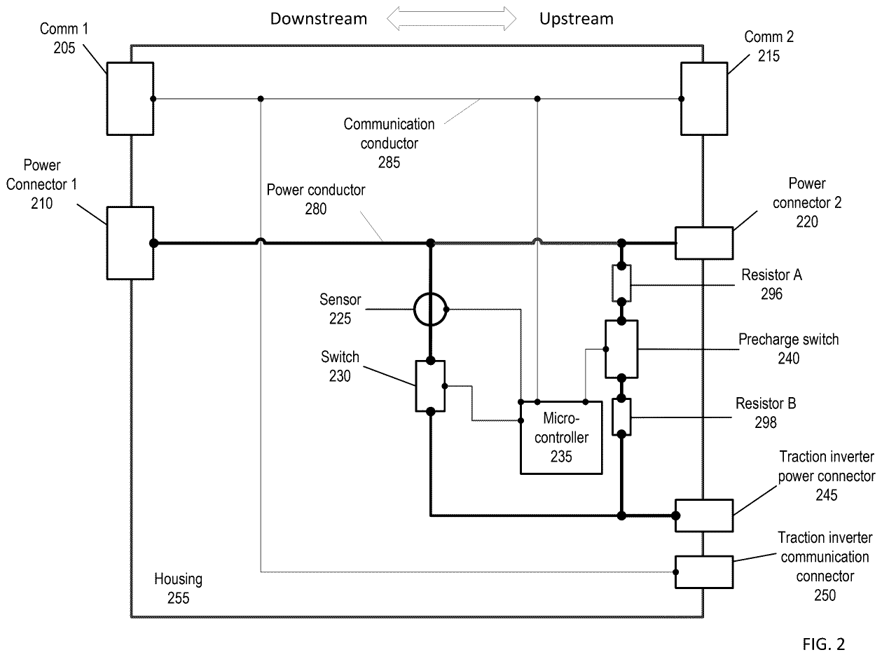

FIG. 2 shows an example of a configured section (e.g., module) of a configurable (e.g., modular) trailer that may further comprise a traction communication circuit and a traction power system. The configured section (e.g., module) of a configurable (e.g., modular) trailer housing 255 may further comprise a traction invertor power connector 245 and/or a traction inverter communication connecter 250. The traction inverter communication connector 250 may be configured to communicate with a traction motor inverter and may be further connected to a communication connector 285 connecting a upstream communication connector 215 (e.g., comm 2), a downstream communication connector 205 (e.g., comm 1), and/or a microcontroller 235.

A power conducting circuit 280 (e.g., power conductor) may comprise, and electrically connect, an upstream power connector 220 (e.g., power connector 2), downstream power connector 210 (e.g., power connector 1), a switch 230, and/or a precharge switch 240 that may be connected in parallel to the switch 230. The switch 230 and/or the precharge switch 240 may be used to electrically connect, and provide power, to one or more power traction inverter power connectors (e.g., traction inverter power connector 245). The switch 230 and/or precharge switch 240 may comprise a resistor connected in series with the switch 230 and/or precharge switch 240. The switch 230 and/or precharge switch 240 may comprise a circuit, for example, that comprises a resistor (e.g., Resistor A 296 and/or Resistor B 298) connected in series with the switch 230 and/or the precharge switch 240. The resistor may comprise a resistance value and power rating necessary to achieve a determined current flow, voltage drop, power loss, etc. The resistor may comprise a resistance value of 50 ohms and a power rating of 100 watts, for example, if the designed load voltage is 50 volts, the supply voltage is 100 volts, and the design requires a current of 1 amp or if the voltage load voltage is 50 volts, the supply voltage is 120 volts, and the design requires a current less than 1.4 amps.

A communication conductor 285 may electrically connect communication circuit nodes. The circuit nodes of the communication conductor 285 may comprise an upstream communication connector 215 (e.g., comm 2), a downstream communication connector 205 (e.g., comm 1), and/or a microcontroller 235. The microcontroller 235 may control the communication circuit nodes.

A microcontroller 235 may be electrically connected to a sensor 225, a communication conductor 285, a switch 230, and/or a precharge switch 240. The sensor 225 may comprise one or more of a current sensor, a voltage sensor, a power sensor, etc. The sensor may indicate, for example, if the current, the voltage, and/or the power is sufficient for the switch 230 to connect the traction inverter power connector. The precharge switch 240 may be configured to provide an adjustable current, voltage, and/or power to the traction inverter power connector 245.

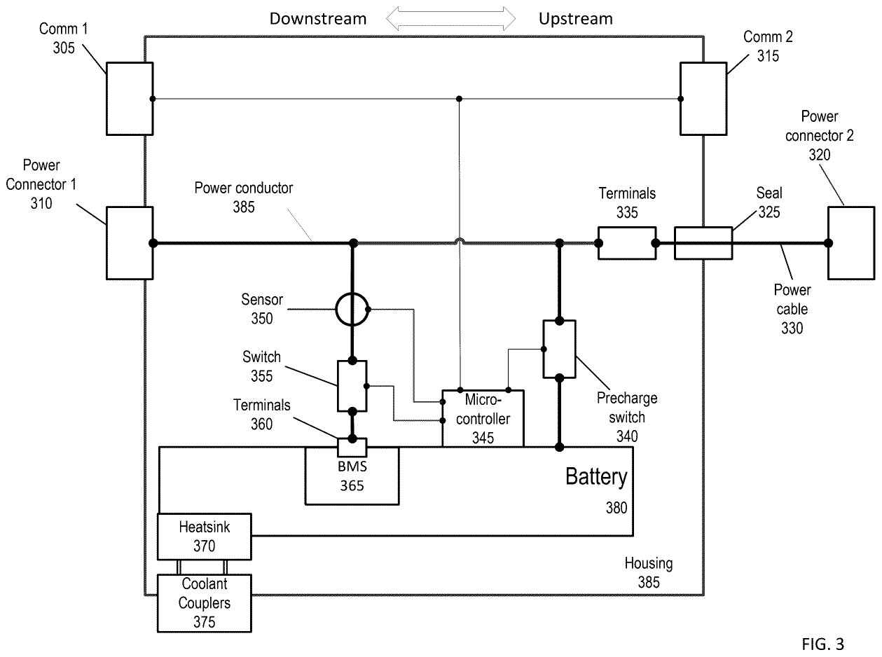

FIG. 3 shows an example of a configured section (e.g., module) of a configurable (e.g., modular) trailer that may further comprise a battery and/or a battery management system for use by the configured section (e.g., module) of a configurable (e.g., modular) trailer and/or other electrically connected devices. A battery 380 and/or a battery management system 365 (BMS) may be electrically connected to a power conductor 385 via terminals 360. The battery may provide a DC voltage to one or more electrically connected power connectors (e.g., power connector 1 310, power connector 2 320, etc.). The one or more electrically connected power connectors (e.g. power connector 1 310, power connector 2 320, etc.) may charge the battery 380. The BMS 365 may be a dedicated system overseeing control of the battery 380 (e.g., one or more battery cells). The BMS 365 may provide for monitoring of the battery 380, protection of the battery 380, determining the operating state of the battery 380, optimizing performance of the battery 380, and/or reporting the operational status of the battery 380.

A voltage of the battery 380 may be determined by a number of cells in a battery 380 and/or the individual cell voltage. A battery 380 may have a DC voltage of 1000 V, for example, if 10 cells each with a voltage of 100 V are connected in series. The output voltage of a battery may be stepped down via use of a voltage divider. The output voltage of a 1000 V battery may be divided into 5 equally divided voltage steps (e.g., 1000 VDC, 800 VDC, 600 VDC, 400 VDC, and 200 VDC) with a total current of 1 amp, for example, if a 200 ohm resistor connects the higher voltage level to the next lower voltage level. A microcontroller 345 may connect to a communication line connecting one or more communication terminals (e.g., comm 1 305, comm 2 315, etc.). The microcontroller may connect to and receive data from a sensor 350 that may monitor current, voltage, and/or power levels of the power conductor 385. The microcontroller may control a switch 355 and/or a precharge switch 340 that may connect and/or disconnect the power conductor 385 to the battery 380. The switch 355 and/or the precharge switch 340 may connect the power conductor 385 to the battery 380, for example, if either the switch 355 or the precharge switch 340 is closed. The switch 355 and/or the precharge switch 340 may disconnect the power conductor 385 and the battery 380, for example, if both the switch 355 and the precharge switch 340 are opened. The switch 355 and the precharge switch 340 may be connected in parallel.

A configured section (e.g., module) of a configurable (e.g., modular) trailer may comprise a plurality of power converters. One or more of the power converters may convert direct current (DC) to alternating current (AC) and/or AC to DC, may change a frequency of the current (e.g., an AC to AC power converter), may change a voltage (e.g., an AC to AC power converter or a DC to DC power converter), etc. One or more of the power converters may perform a combination of the above. A configured section (e.g., module) of a configurable (e.g., modular) trailer may comprise a plurality of inverters, for example, to change DC to AC. One or more of the plurality of inverters may comprise an inverter of an electric motor and/or a traction inverter.

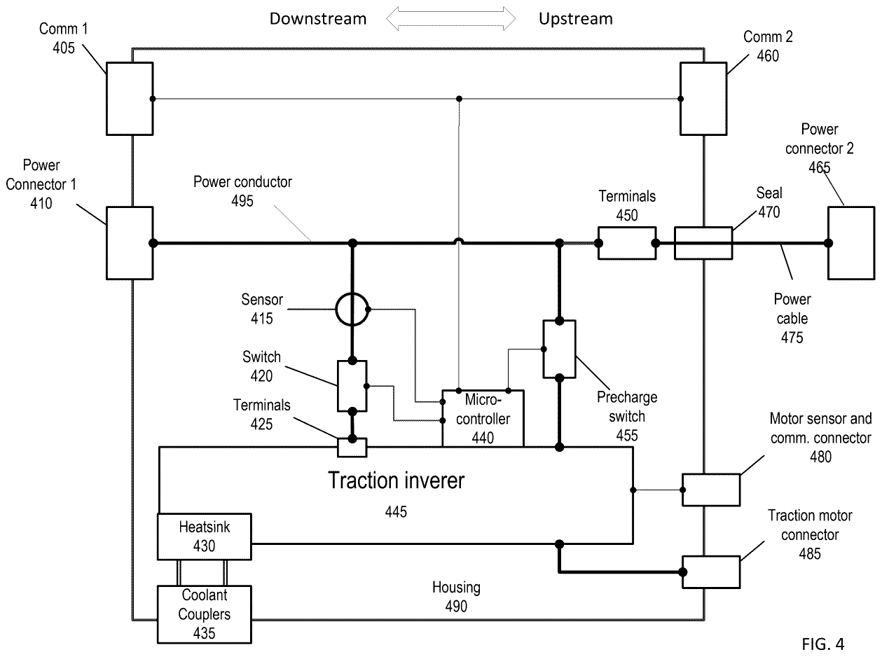

FIG. 4 shows an example of a configured section (e.g., module) of a configurable (e.g., modular) trailer that may further comprise a traction inverter. A traction inverter 445 may be electrically connected to a power conductor 495 via a terminal 425 and a switch 420. The traction inverter 445 may also be electrically connected to a power conductor 495 via a precharge switch 455. The switch 420 and the precharge switch 455 may electrically connect the power conductor 495 and the traction inverter 445 in parallel. A microcontroller 440 may be connected to a sensor 415 that may determine a voltage, a current, and/or a power from the power conductor 495 to the traction inverter 445. The microcontroller 440 may control the switch 420 and/or precharge switch 455 that may electrically connect the power conductor 495 to the traction inverter 445. The traction inverter may receive sensor and communication information from a traction motor via a motor sensor and/or communication sensor 480. The power output of the traction inverter 445 may pass through a traction motor connector 485 to a traction motor. The motor sensor and communication connector 480 and/or traction motor connector 485 may be integrated with the housing 490 of a configured section (e.g., module) of a configurable (e.g., modular) trailer.

A housing 490 of a configured section (e.g., module) of a configurable (e.g., modular) trailer may comprise an integrated power socket that may be configured to connect to an inverter of an electric motor. DC output of the configured section (e.g., module) of a configurable (e.g., modular) trailer may be supplied to an external inverter. The configured section (e.g., module) of a configurable (e.g., modular) trailer may supply an AC output of varying wave form and/or power, for example, if the configured section (e.g., module) of a configurable (e.g., modular) trailer comprises an inverter.

A traction inverter 445 may be cooled by a heat exchanger 430 (e.g., a heatsink). Coolant to remove heat from the traction inverter 445 may be supplied to the heat exchanger 430 using coolant couplers 435 (e.g., coolant fittings, fittings, etc.). Coolant couplers 435 (e.g., fittings) may pass through a housing 490, or alternatively, coolant couplers 435 (e.g., fittings) may be integrated into the housing 490.

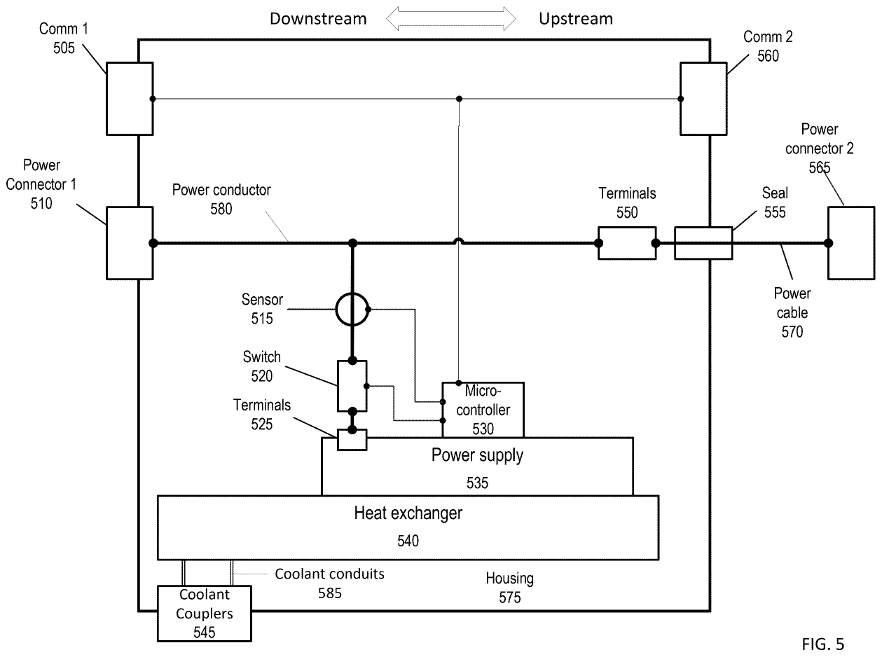

FIG. 5 shows an example of a configured section (e.g., module) of a configurable (e.g., modular) trailer comprising a power supply and/or a heat exchanger (e.g., a heatsink). The power supply 535 may be electrically connected to a power conductor 580 via a terminal 525. A switch 520 may connect and/or disconnect the power supply 535 from the power conductor 580. The switch 520 may be controlled by a microcontroller 530. The microcontroller 530 may receive measurements from a sensor 515 to determine the state of the switch 520. The sensor may monitor the current, the voltage, and/or the power to the power supply 535.

A heat exchanger 540 may be used to remove heat generated in a power supply 535. The heat generated in the power supply may be exchanged in the heat exchanger 540 using coolant that may be supplied to the heat exchanger 540 via coolant couplers 545 (e.g., fittings). The coolant couplers 545 (e.g., fittings) may be integrated into a housing 575 of a configured section (e.g., module) of a configurable (e.g., modular) trailer. Coolant conduits 585 may provide coolant flow from the coolant couplers 545 (e.g., fittings) to the heat exchanger 540 and/or from the heat exchanger 540 to the coolant couplers 545 (e.g., fittings). The heat generated in the power supply may be transferred to the coolant flowing through the coolant conduits 585 and brought to an external heat sink to be cooled and/or to be used to heat an external device. Alternatively to a fluid passing through a heat exchanger, a heat exchanger may use thermoelectric cooling. Thermoelectric cooling may use the Peltier effect. The Peltier effect may transfer heat from a cold side to a hot side using an electric current.

A configured section (e.g., module) of a configurable (e.g., modular) trailer be designed to complement a trailer and/or use of a trailer. A configured section (e.g., module) may comprise a battery pack that may be used by an EV to extend the range of an EV. An electric semi-truck may be able to swap out a configurable (e.g., modular) trailer consisting of battery packs during delivery. A configured section (e.g., module) may comprise an internal combustion engine (ICE) range extender. The ICE range extender may be used to generate electric power that may be used to recharge a battery pack and/or provide electric power for connected devices. A configured section (e.g., module) may comprise an eAxle that may decelerate a trailer by converting rotational energy of an axle of a trailer into electrical energy. The eAxle may also provide additional torque and/or horse power, for example, if needed, or the eAxle may detect slip and adjust the axle speed to minimize any negative effects of the slip. The configurable (e.g., modular) trailer may comprise a hydrogen fuel cell pack. A hydrogen fuel cell pack may use a catalyst to chemically combine hydrogen with oxygen to produce a current that may drive an EV and/or charge a battery.

A configurable (e.g., modular) trailer may comprise one or more configured sections (e.g., modules). Each configured section (e.g., module) may comprise a housing, one or more upstream power connectors, one or more downstream power connectors, one or more upstream communication connectors, one or more downstream communication connectors, one or more switches, one or more power conductors, one or more communication conductors, and/or one or more controllers. The one or more power conductors may comprise power nodes that may electrically connect the one or more upstream power connectors, the one or more downstream power connectors, and/or the one or more switches. The one or more communication conductors may electrically connect the one or more downstream communication connectors, the one or more downstream communication connectors, and/or the one or more controllers. At least one of the one or more configured sections (e.g., modules) may comprise an upstream communication connector.

One or more configured sections (e.g., modules) of a configurable (e.g., modular) trailer may be connected in series (e.g., a daisy chain). A first configured section (e.g., module) of the one or more configured sections (e.g., modules) may be connected to a second configured section (e.g., module) of the one or more configured sections (e.g., modules), for example, if one of one or more upstream communication connectors of the first configured section (e.g., module) is connected to one of one or more downstream communication connectors of the second configured section (e.g., module) and if one or one or more upstream power connectors of the first configured section (e.g., module) is connected to one of one or more downstream power connectors of the second configured section (e.g., module).

A configurable (e.g., modular) trailer may comprise one or more configured sections (e.g., modules) and/or pieces of ancillary equipment. The configured sections (e.g., modules) that comprise a configurable (e.g., modular) trailer may be determined based on design specifications of the configurable (e.g., modular) trailer. A configurable (e.g., modular) trailer may comprise a battery configured section (e.g., battery module, battery pack, etc.), for example, if the configurable (e.g., modular) trailer is designed to provide a stable DC power source. A configurable (e.g., modular) trailer may comprise a battery configured section (e.g., battery module, battery pack, etc.) and an inverter configured section (e.g., module), for example, if the configurable (e.g., modular) trailer is designed to provide a stable DC power source and a stable AC power source. Configurable (e.g., modular) trailers may include trailers designed for food production, for food service, for transport of different cargos, for storage of power, etc.

Ancillary equipment that a configurable (e.g., modular) trailer may comprise include cooling devices, towing sensors, and/or bi-directional DC/DC chargers. A cooling device may comprise a radiator heat exchanger and a fan where the fan may cause air to pass around coolant carrying tubes to remove heat from the coolant within the coolant carrying tubes. A cooling device may be a heat pump and/or chiller. A towing sensor may include a sensor to determine tow engagement. A towing sensor may include force sensors to determine towing force that may be used to determine the amount of weight towed. A bi-directional DC/DC charger may be used to electrically connect two DC sources. A bi-directional DC/DC charger may be used to charge a second battery using a first battery. A configurable (e.g., modular) trailer comprising a battery configured section (e.g., battery module, battery pack, etc.) may charge electrically connected EV, for example, if the first battery is the battery configured section (e.g., battery module, battery pack, etc.) and the second battery is the EV battery.

Configurable (e.g., modular) trailers may be designed to further the capabilities of trailers currently used. A configurable (e.g., modular) trailer may be designed to support a portable kitchen. The configurable (e.g., modular) trailer may be configured with a battery and/or multiple electrical lines and/or buses of varying power and/or currents to provide power to electric stoves, ovens, kitchen tools, refrigerators, etc. The configurable (e.g., modular) trailer may be configured to connect to solar cells to extend the time the portable kitchen may be required to operate. Configurable (e.g., modular) trailers may be designed to carry cargo. A configurable (e.g., modular) trailer may be configured with a battery and/or external refrigeration power receptacles, for example, if the configurable (e.g., modular) trailer is configured to power a refrigerated truck. A configurable (e.g., modular) trailer may be designed to provide portable shelters and/or work spaces. The configurable (e.g., modular) trailer may be configured to be taken to a site experiencing a natural disaster, for example, if the configurable (e.g., modular) trailer is configured with a battery configured section (e.g., battery module, battery pack, etc.), a power configured section (e.g., module), and/or ancillary equipment to power the living space of the configurable (e.g., modular) trailer.

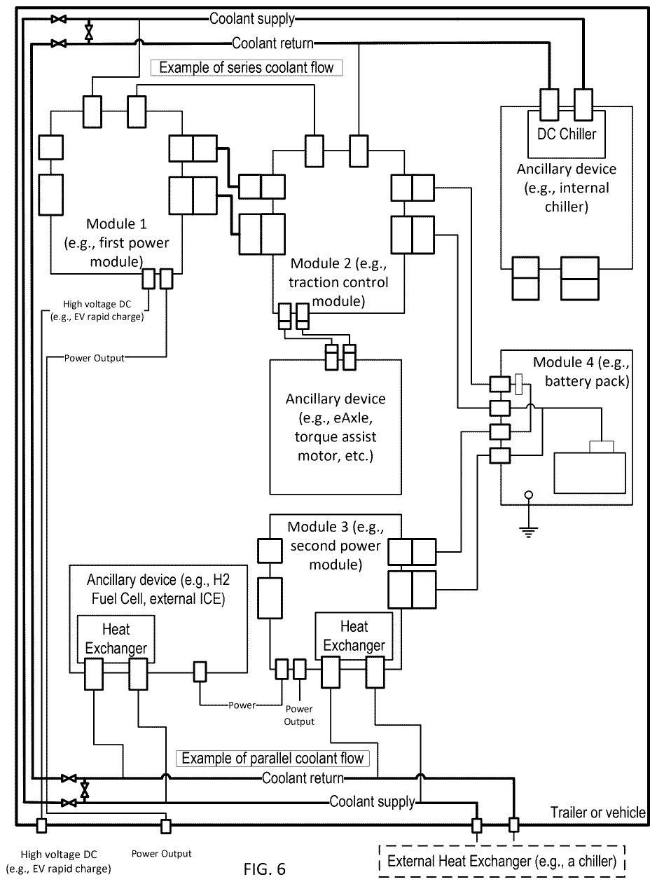

A configurable (e.g., modular) trailer may comprise a distributed system of one or more configured sections (e.g., modules). The configured sections (e.g., modules) comprising the configurable (e.g., modular) trailer may be determined based on a number of design parameters. A configurable (e.g., modular) trailer may have one or more battery packs, for example, based on voltage and/or milli-ampere hours requirements. A configurable (e.g., modular) trailer may have one or more power configured sections (e.g., modules). A power configured section (e.g., module) may have a high voltage EV charging connector, for example, if the configurable (e.g., modular) trailer is configured for fast charging of the one or more battery packs. The configurable (e.g., modular) trailer may further comprise one or more ancillary devices (e.g., an eAxle, a traction control motor, etc.). FIG. 6 shows an example block diagram of a configurable (e.g., modular) trailer comprising a battery pack, a first power configured section (e.g., module), a second power configured section (e.g., module), a traction control configured section (e.g., module), and an ancillary device (e.g., an eAxle, a torque assist motor, etc.).

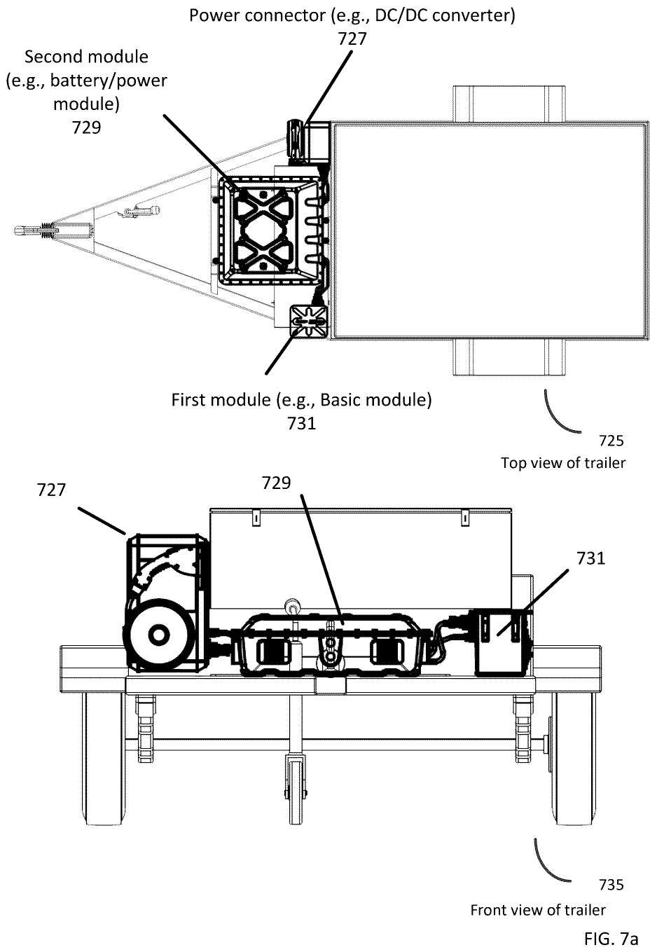

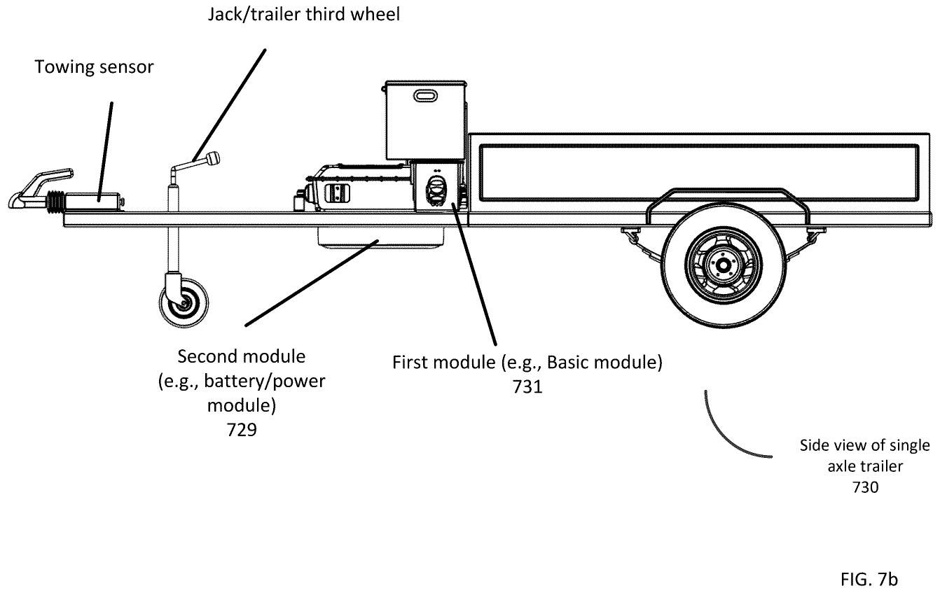

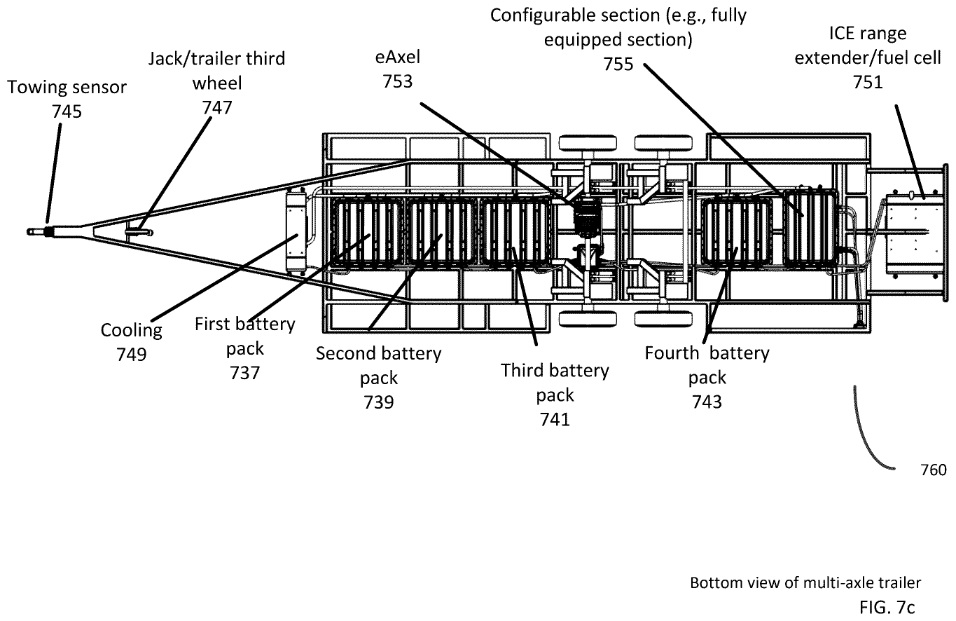

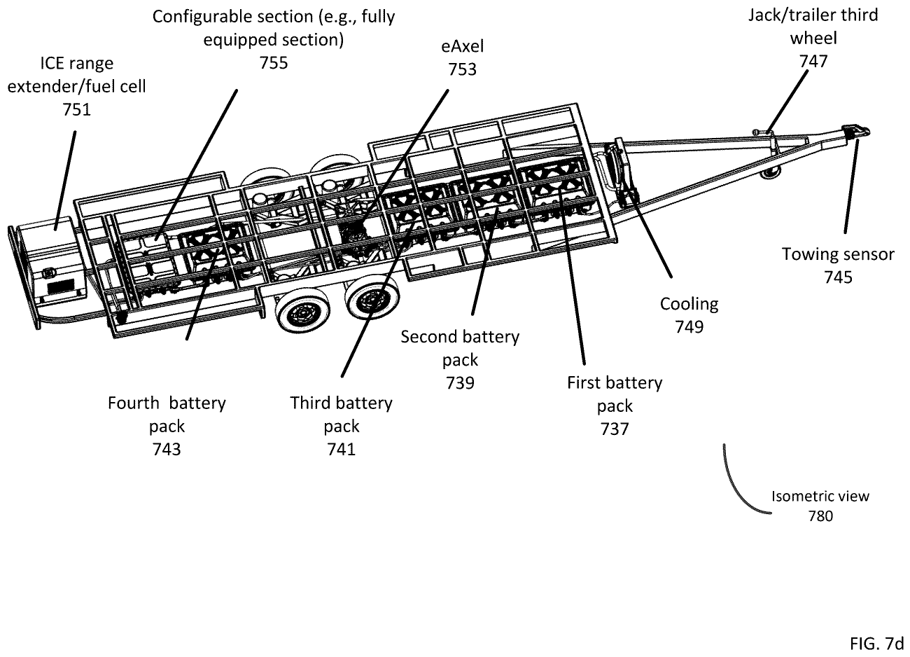

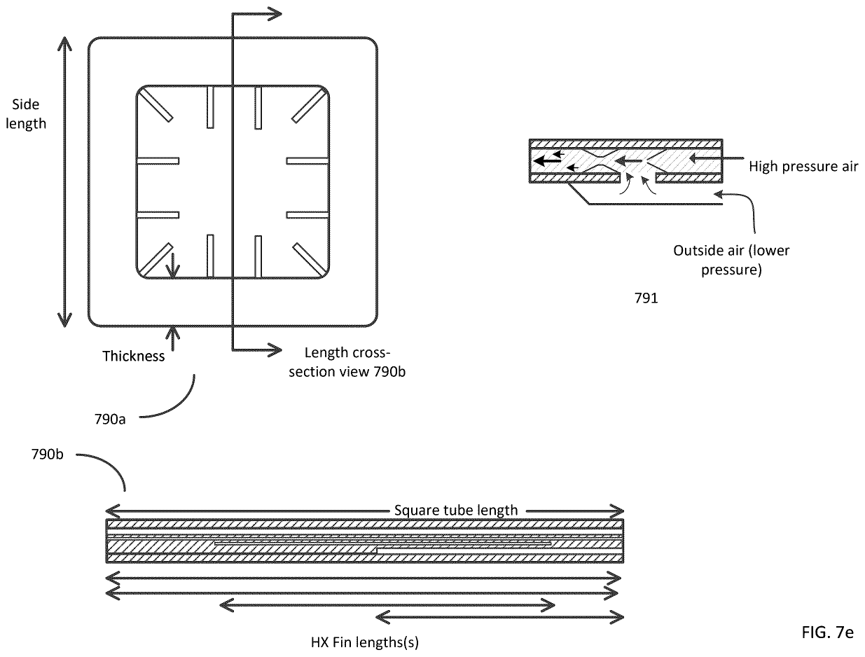

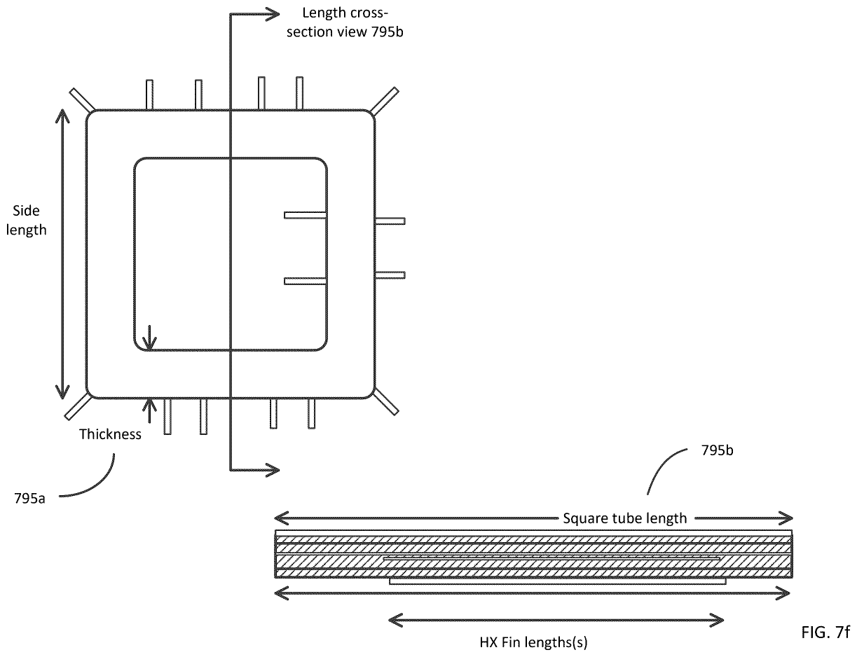

FIGS. 7-10 show examples of configurable trailers. Specifically, FIGS. 7-10 show examples of configurable (e.g., modular) trailers using daisy chain electrical power and electrical communication channels to connect configured trailer sections (e.g., modules). A configurable (e.g., modular) trailer may comprise one or more configurable trailer sections (e.g., modules). A configurable (e.g., modular) trailer may be equipped, for example, with one or more battery packs, one or more power configured sections (e.g., modules), and/or one or more pieces of ancillary equipment. The number of battery packs may be determined, for example, based on the maximum voltage required, the amount of time the configurable (e.g., modular) trailer is away from a power source, and/or the amount of current and/or power required to operate any electrical pieces of equipment that may be included in the configurable (e.g., modular) trailer.

A configurable (e.g., modular) trailer may comprise a battery. An EV may be configured to electrically connect to the battery. The EV may have its range extended by using the configurable (e.g., modular) trailer equipped with the battery. The configurable trailer may further comprise an eAxle to regenerate the battery of the configurable trailer. An EV with a configurable trailer comprising a battery may swap the trailer for a second configurable trailer comprising a battery. The EV may swap trailer's with a battery, for example, rather than recharging a battery. Trailer's with batteries may be recharged at sites for EVs to connect and extend their range without needing time to charge the battery.

FIGS. 7a and 7b show examples of single-axle configurable (e.g., modular) trailers. Specifically, FIG. 7a shows a top view 725 and a front view 735 of a configurable (e.g., modular) trailer with two configured sections (e.g., modules), and FIG. 7b shows a side view of the configurable (e.g., modular) trailer. A first configured section 731 (e.g., module) of the configurable (e.g., modular) trailer may be a basic configured section (e.g., module). A basic configured section (e.g., module) may comprise a power conductor with an upstream power conductor and a downstream power connector, an upstream communication connector and a downstream communication connector, and a microcontroller. The basic configured section (e.g., module) may further comprise connecting terminals and/or electrical connectors for external devices. The basic configured section (e.g., module) may comprise low voltage DC receptacles integrated into the housing to power kitchen equipment, for example, if the configurable (e.g., modular) trailer is configured as a portable kitchen. A second configured section 729 (e.g., module) of the configurable (e.g., modular) trailer may comprise a battery configured section (e.g., battery module, battery pack, etc.). The battery configured section (e.g., a battery module, a battery pack, etc.) may be configured to receive electric power from a number of sources and/or may be configured with a power converter and/or inverter to convert AC to DC and/or DC to AC and/or provide electrical power of different voltage values. The configurable trailer may further comprise a power connector 727 (e.g., a DC/DC converter). The configurable trailer may further comprise a jack/trailer third wheel, a towing sensor, etc. The jack/trailer third wheel may comprise a microprocessor and a motor to drive the third wheel and position the configurable trailer. The towing sensor may comprise pressure sensors to determine where and with what force a tow connections is made.

FIGS. 7c and 7d show examples of a multi-axle configurable (e.g., modular) trailers. Specifically, FIGS. 7c and 7d show a bottom view 760 and a top view 780 of a configurable (e.g., modular) trailer with four battery packs 737-743 (e.g., a first battery pack 737, a second battery pack 739, a third battery pack 741, a fourth battery pack 743, etc.), a variety of ancillary pieces of equipment (e.g., a towing sensor 745, an e-jack/e-trailer third wheel 747, a cooling device 749, an ICE range extender 751, and/or an eAxle 753) and an energetic configured section 755 (e.g., energetic module) that may provide AC and/or DC electrical power of different voltages to other equipment or exterior devices. The ICE range extender 751 may power a generator that may be used to charge the one or more battery configured sections 737-741 (e.g., battery packs, battery modules, etc.). The battery packs 737-741 and/or ICE range extender generator may provide power to the energetic configured section 755 (e.g., energetic module). The energetic configured section 755 (e.g., energetic module) may be configured with one or more exterior power connectors (e.g., an EV charging connector, a high voltage DC in, solar panel connectors, AC power in, etc.) that may provide power out and/or in of different values.

A configurable trailer may configured with a frame comprising a cooling system. A frame cooling system may protect the cooling system from debris on the road and/or in the air. Debris may comprise bugs, trash, pieces of metal, etc. The frame may comprise passive air intake to the frame. The frame may comprise scoops to gather and force air into the frame. Also, or alternatively, the frame may comprise forced air intake (e.g., active air intake) to the frame. Forced air may comprise fans, for example, to direct air into the frame cooling system. A frame cooling system may comprise internal fins thermally connected to the inside of the frame. Air flowing over the fins may transfer heat from the frame to the air flow. Alternatively, the frame may comprise internal fluid lines to protect the fluid lines from materials on the road and/or in the air.

FIGS. 7e and 7f show examples of frames configured with cooling systems (e.g., heat exchange systems). FIG. 7e shows an example of a heat exchange system comprising fins that provide greater surface area for heat transfer. Heat transfer fins may be affixed, for example, to the interior of a tube. Heat transfer fins may be affixed to the interior of a square tubing 790a. The fins may be affixed by welding, by a thermally conductive material (e.g., thermally conductive epoxy), etc. The fins may be attached mechanically (e.g., bolt and nut) with a thermally conductive grease. The cross section along the length of the tubing 790b shows that the fins may be of different lengths. The fins may be of different lengths, for example, based on heat transfer needs and experimental results. The fins may be of different lengths to couple cooler lengths to warmer lengths. The fins may comprise different materials with different thermal conductivity profiles. Air may be pulled into the tubing using a fan and/or other methods. Air may be pulled into the tubing, for example, using a venturi pump 791. By pressurizing air and directing the air through a nozzle a low pressure region may be created that entrains outside air into the tubing. The potential energy of the compressed air, for example, may converted into an increase the volume of air flowing through the tubing. The pressure of the high pressure air may be varied based on the cooling power needed. The pressure of the high pressure air may be increased, for example, if increased cooling is needed. Alternatively, the pressure of the air may be decreased, for example, if decreased cooling is needed.

FIG. 7f shows an alternative example of a heat exchange system comprising fins and tubing. Also, or alternative, to fins coupled to the inside of a tube, heat transfer fins may be affixed, for example, to the interior of a tube. Fins may be attached to the exterior of the tubing 195a and/or fins may be attached to the interior of the tubing. The cross section along the length of the tubing 795b shows that the fins may be of different lengths.

Thermal conductive devices (e.g., heat transfer devices) may comprise active and/or passive thermal conduction. A passive heat transfer device relies on the natural thermal conductivity of a device (e.g., a thermal bus bar). An active heat transfer device comprises a means for moving a heat transfer fluid over a heat exchanger (e.g., a chiller and chill water, or a fan and fins). An active heat transfer device may provide more cooling.

A configured section (e.g., a module) of a configurable (e.g., modular) trailer may comprise heat transfer devices. Heat transfer devices may comprise fluid flow connectors. Heat transfer devices may comprise braided copper wire. Heat transfer devices may comprise heat pipes, for example, comprising a thermally conductive metal tube with an eternal fluid that moves heat from a high heat area to a low heat area. Heat transfer devices may comprise silicon designed for heat transfer. Heat transfer devices may comprise flexible bus bars. Heat transfer devices may comprise thermally conductive rubber.

Mounting fixtures and/or mounting brackets may comprise heat transfer devices. The mounting fixtures may comprise a method for transferring heat from a configured section (e.g., module) to a frame of the configurable trailer and a method for mounting the configured section to the frame, for example, if the mounting fixtures are configured to transfer heat to the frame.

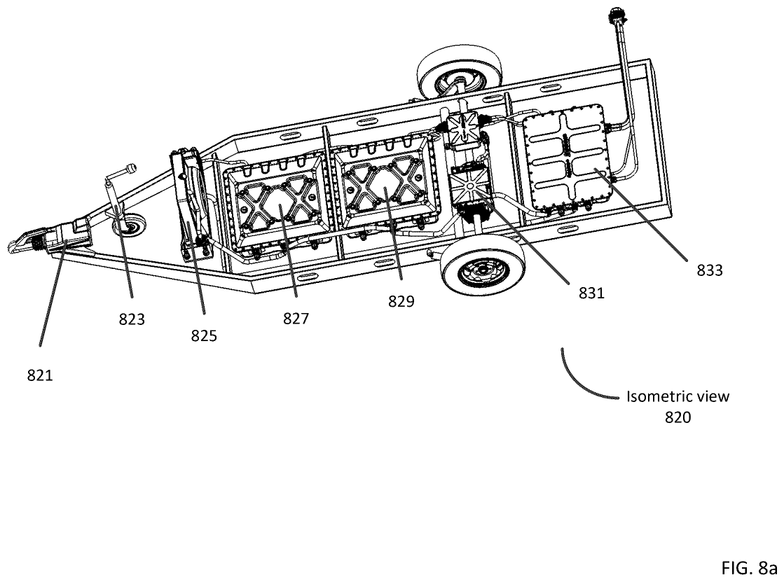

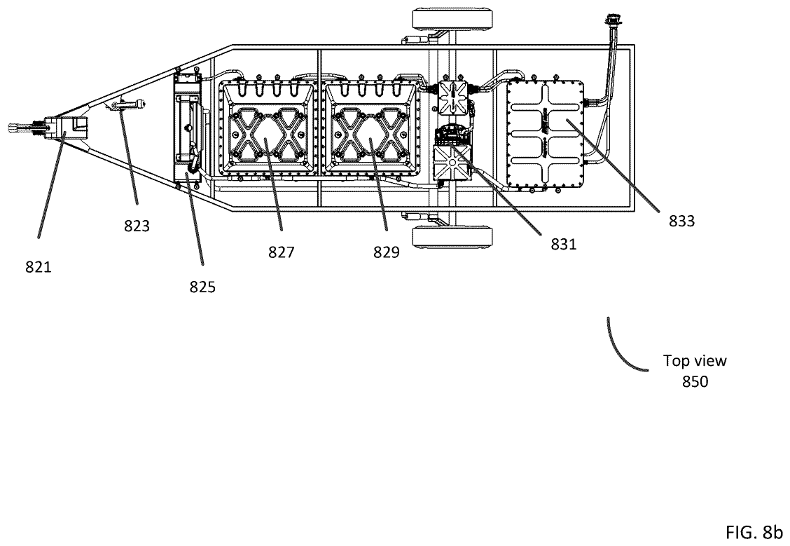

Configurable (e.g., modular) trailers may be designed around existing trailer designs to provide additional features for the user. FIGS. 8a and 8b shows an example of configurable (e.g., modular) trailer comprising two battery packs 827 and 829, a cooler 825 using air as a cooling medium, a towing sensor 821, an eAxle 831, and an energetic configured section 833 (e.g., energetic module). The configurable (e.g., modular) trailer may be designed to transport a vehicle. The vehicle trailer may be configured with one or more batteries and a power configured section (e.g., module), for example, if the configurable (e.g., modular) trailer is designed to charge an electric vehicle as the vehicle is being towed. The owner of an EV may use an EV at a first location, tow their vehicle from the first location to a second location, and may have the EV charged for use in the second location upon arrival. The trailer may be further configured with an ICE range extender, for example, to charge the batteries of the configurable (e.g., modular) trailer and/or EV. The trailer may comprise an eJack/third wheel 823.

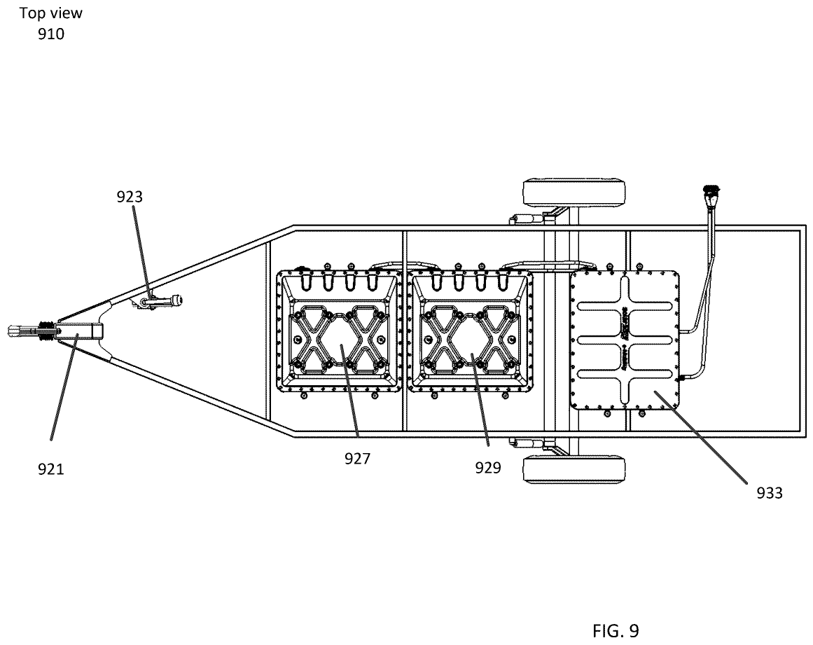

Alternatively to being configured with an ICE range extender to charge battery packs, a configurable (e.g., modular) trailer energetic configured section 831 (e.g., energetic module) may be configured with power-in connectors (e.g., AC in connectors, high voltage DC in connectors, solar panel in connectors, etc.) FIG. 9 show an example of a configurable (e.g., modular) trailer configured with two battery packs 927 and 929 and an energetic configured section 933 (e.g., energetic module). The configurable (e.g., modular) trailer may be configured to receive power from external sources, for example, if the configurable (e.g., modular) trailer is used in locations that have easy access to a number of fast charging sources and/or the configurable (e.g., modular) trailer is designed with solar panels. The trailer may be configured with an eJack 923 and/or a towing sensor 921.

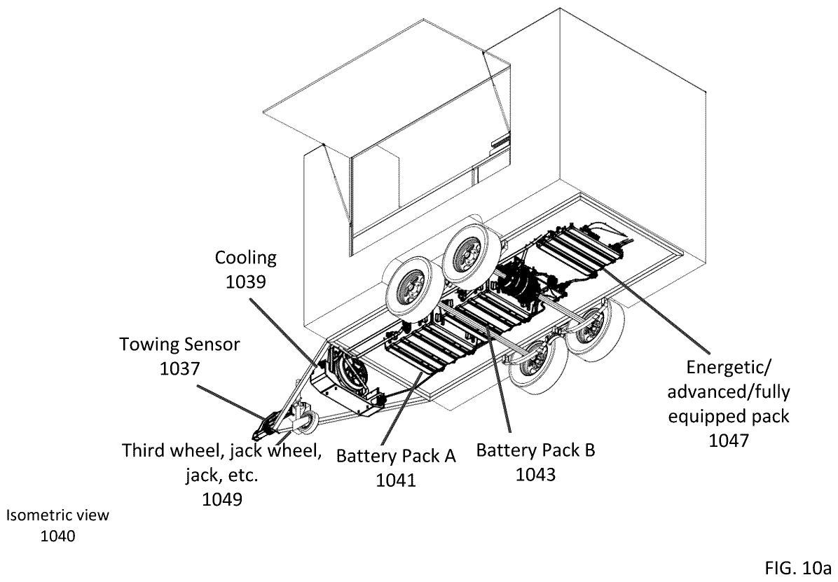

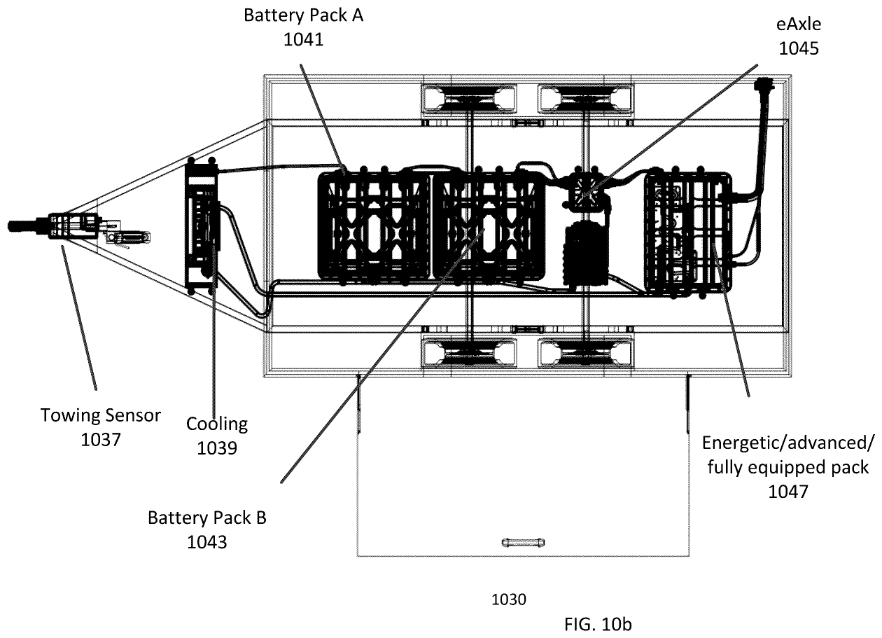

FIGS. 10a and 10b shows an example use of a configurable (e.g., modular) trailers. FIGS. 10a and 10b shows an example of a configurable (e.g., modular) trailer that may be used as a food truck. A configurable (e.g., modular) trailer may provide electrical power of varying voltages to power necessary components of a food truck (e.g., refrigerators, electric stoves, electric deep fat fryers, electric blenders, electric espresso machines, etc.). The configurable (e.g., modular) trailer may provide the electrical power to provide lighting for the configurable (e.g., modular) trailer and/or for lighting external to the configurable (e.g., modular) trailer. The configurable (e.g., modular) trailer may provide electrical power sockets for external devises. The configurable (e.g., modular) trailer may provide either AC power, DC power, or both. The configurable (e.g., modular) trailer may provide AC power and/or DC power of different voltages. The configurable (e.g., modular) trailer may provide AC power of varying frequencies.

The configurable (e.g., modular) trailer may comprise one or more configured sections (e.g., modules). The one or more configured sections (e.g., modules) may be connected in series (e.g., a daisy chain). A first configured section (e.g., module) may be connected to a second configured section (e.g., module), for example, if the upstream communication connector of the first configured section (e.g., module) is connected to the downstream communication connector of the second configured section (e.g., module) and/or the upstream power connector of the first configured section (e.g., module) is connected to the downstream connector of the second configured section (e.g., module). Additional configured sections (e.g., modules) may be connected to provide a configurable (e.g., modular) trailer the necessary components needed. A configurable (e.g., modular) trailer, for example, may comprise a battery configured section (e.g., battery module, battery pack, etc.), a traction inverter configured section (e.g., module), and/or one or more power supply configured sections (e.g., modules).

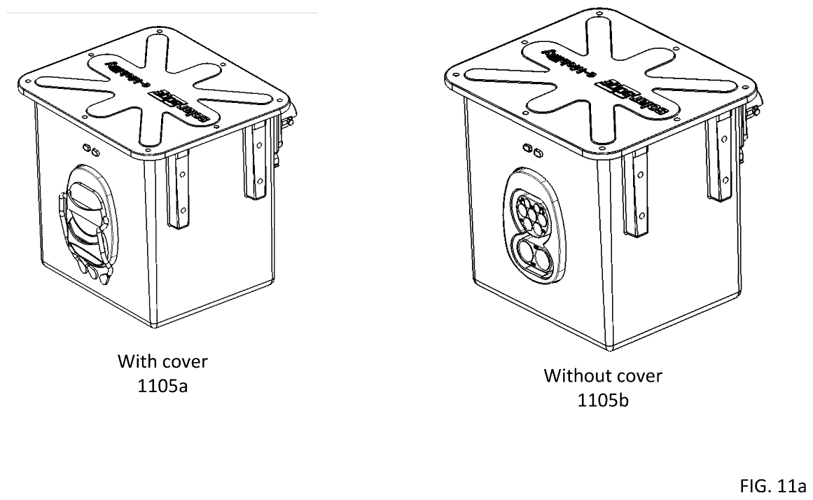

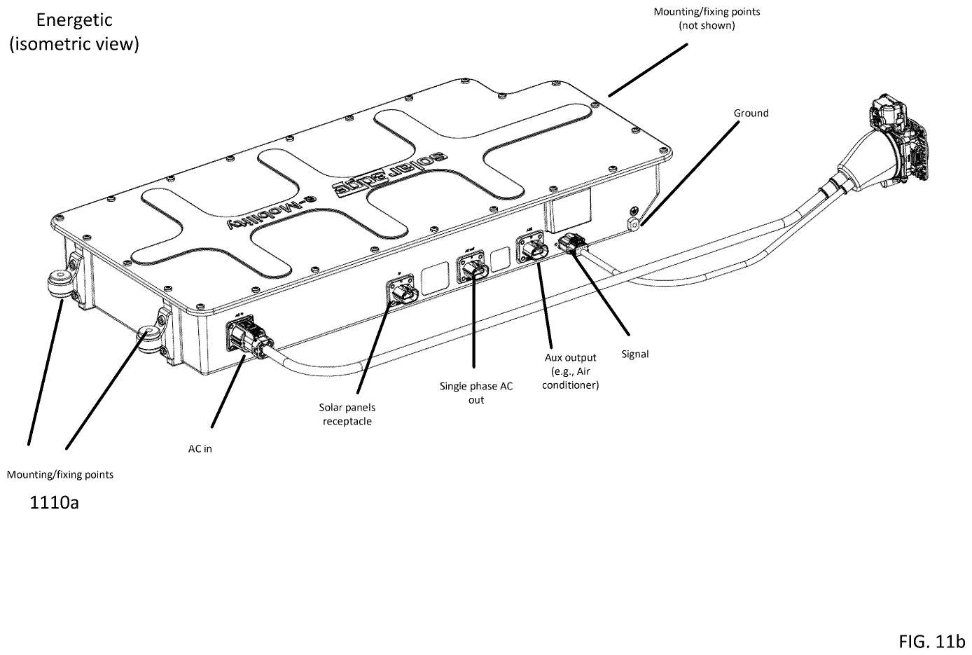

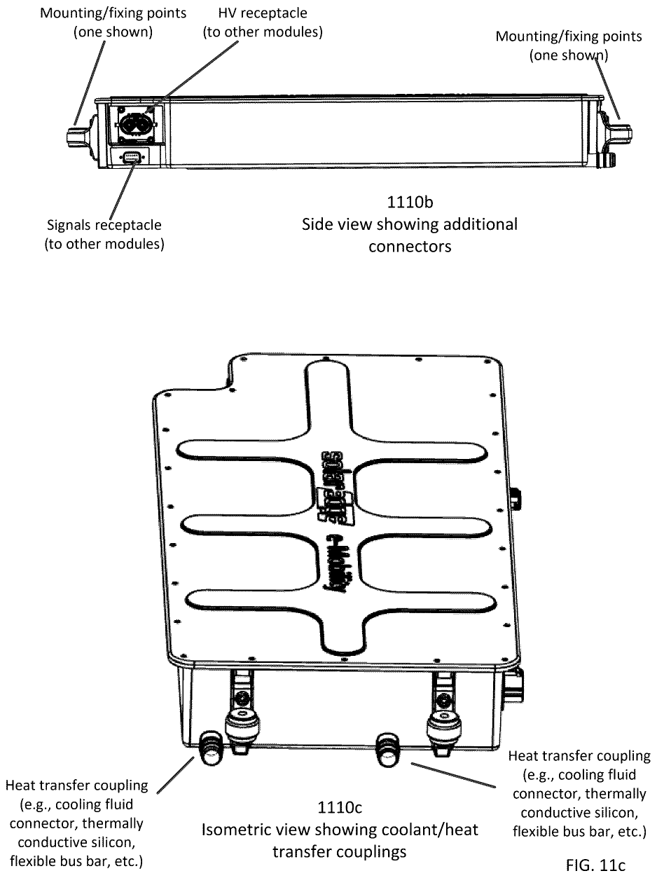

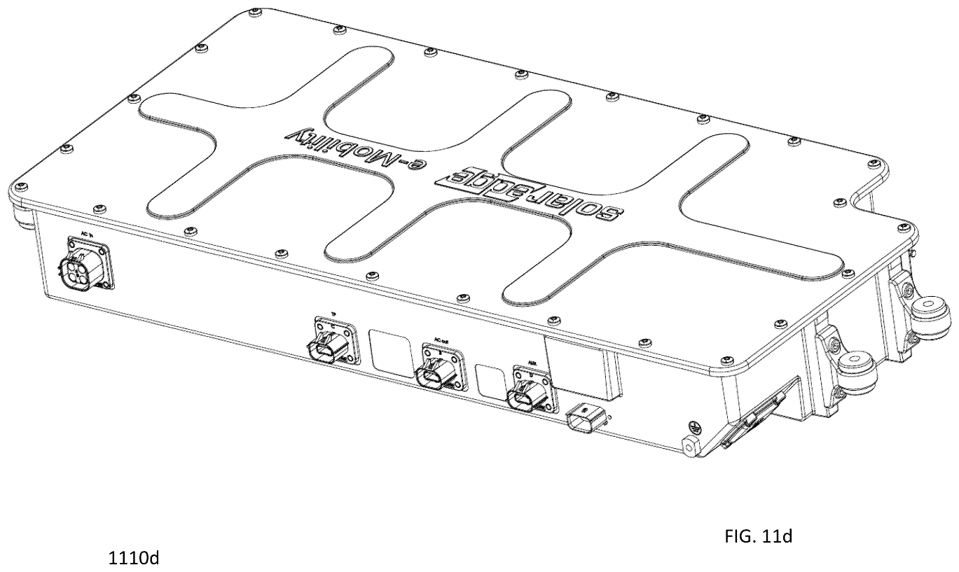

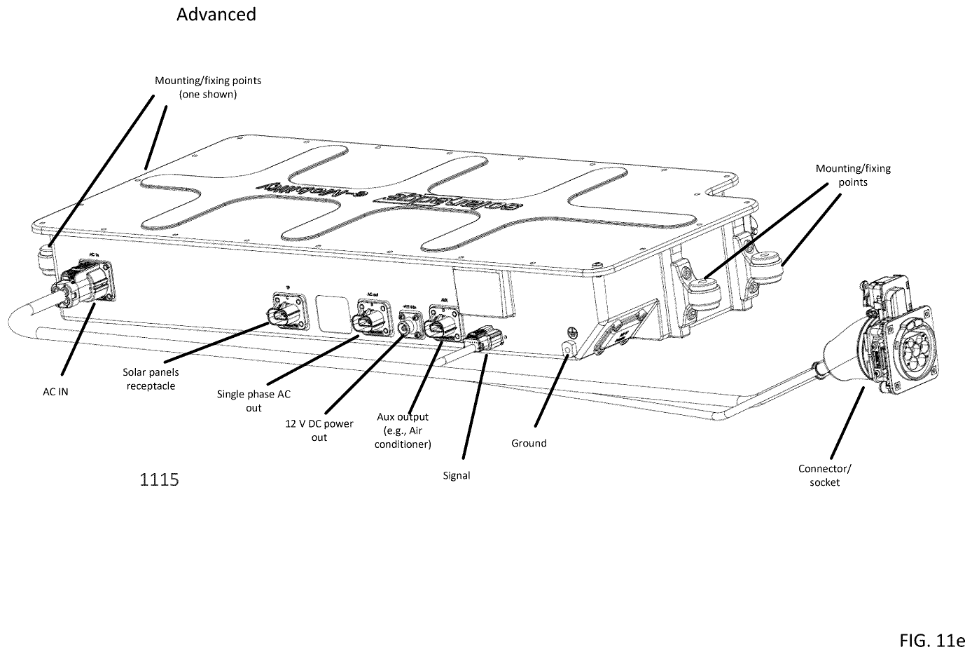

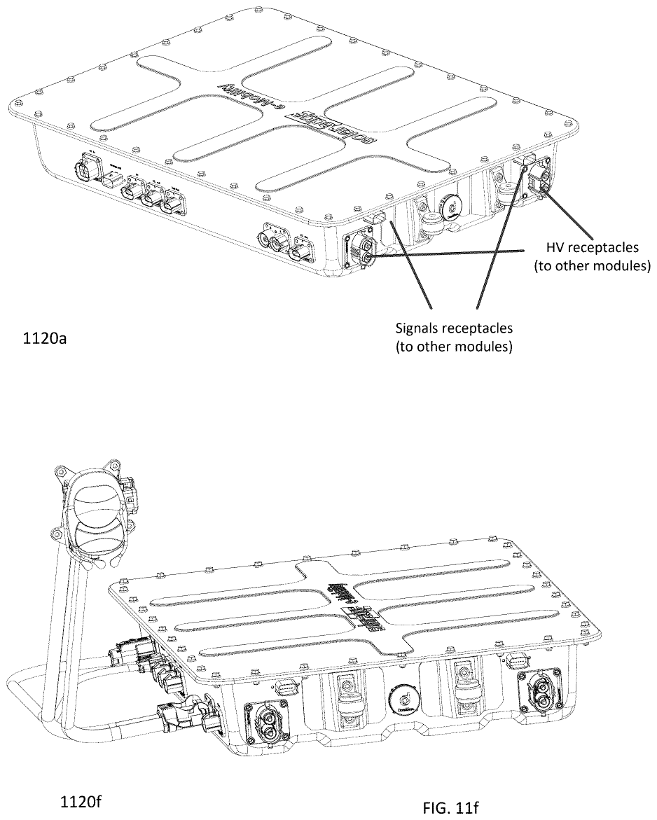

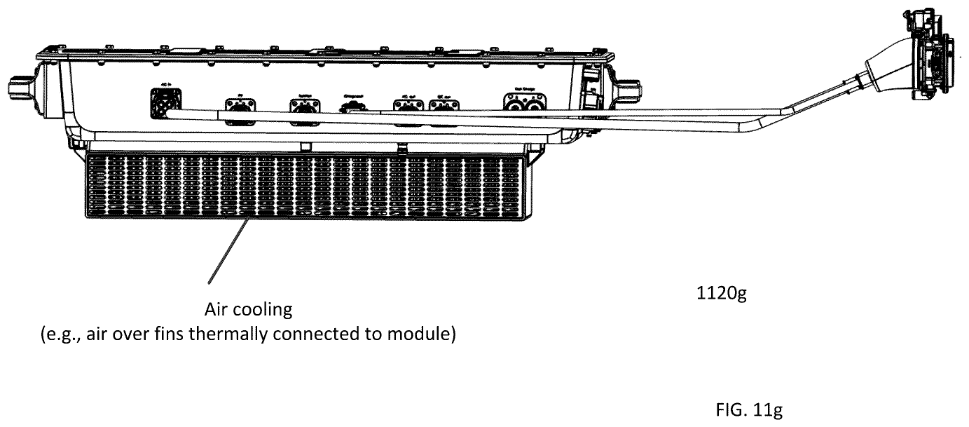

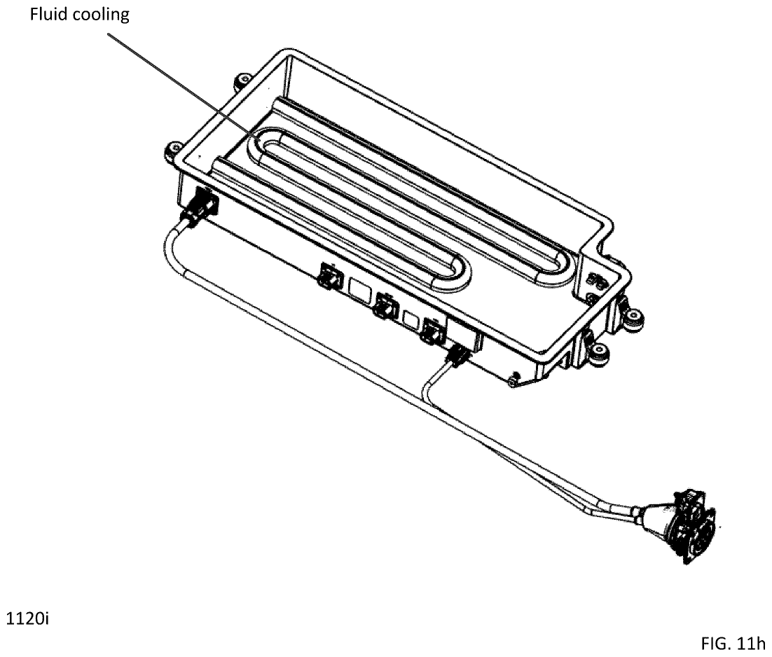

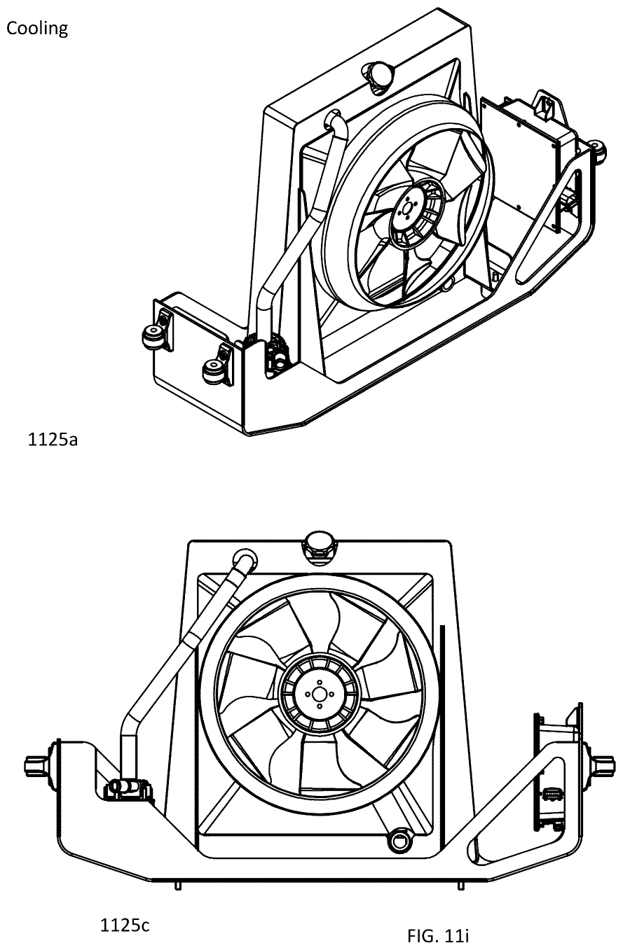

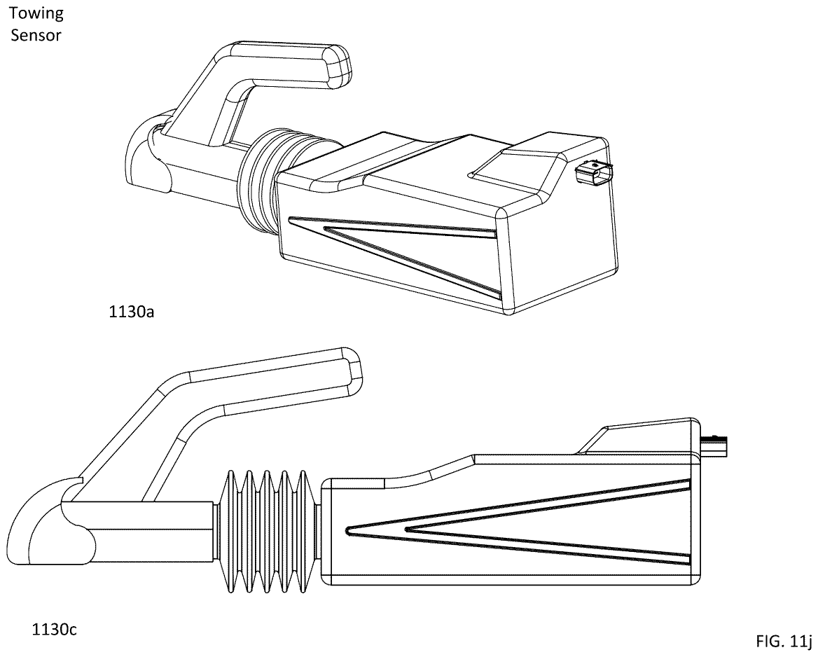

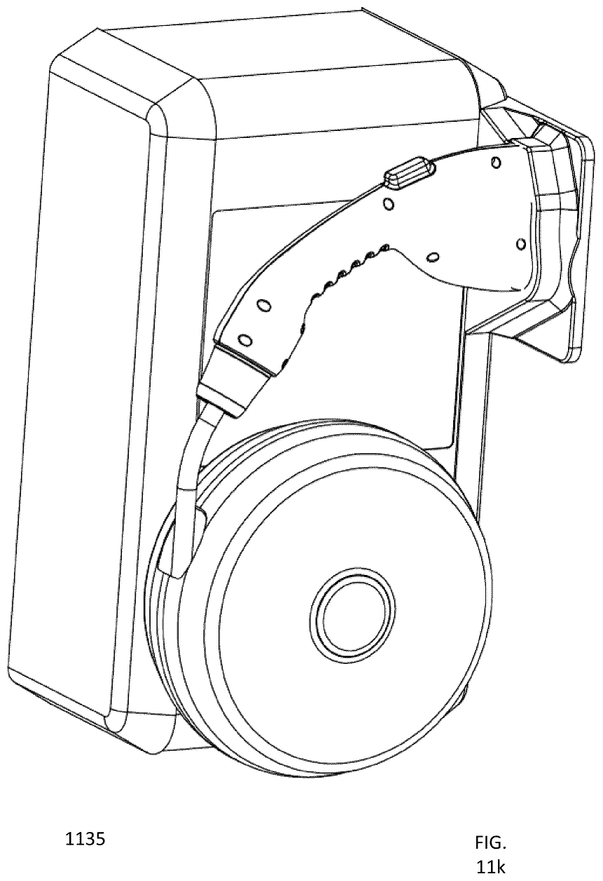

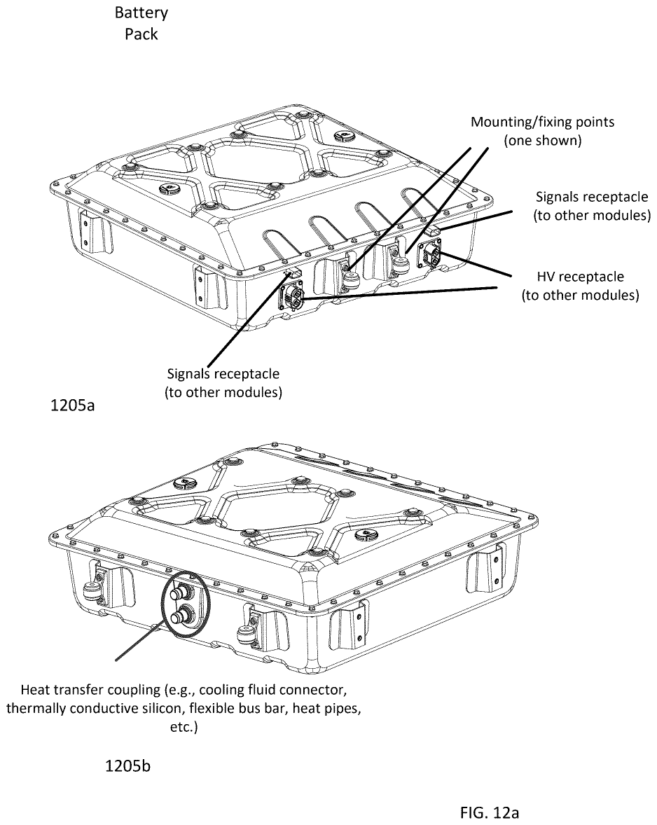

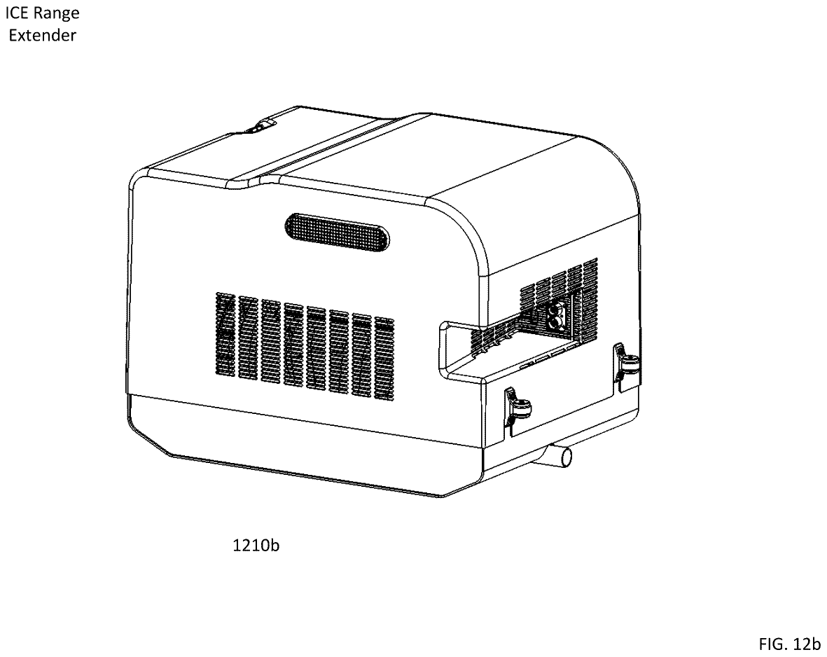

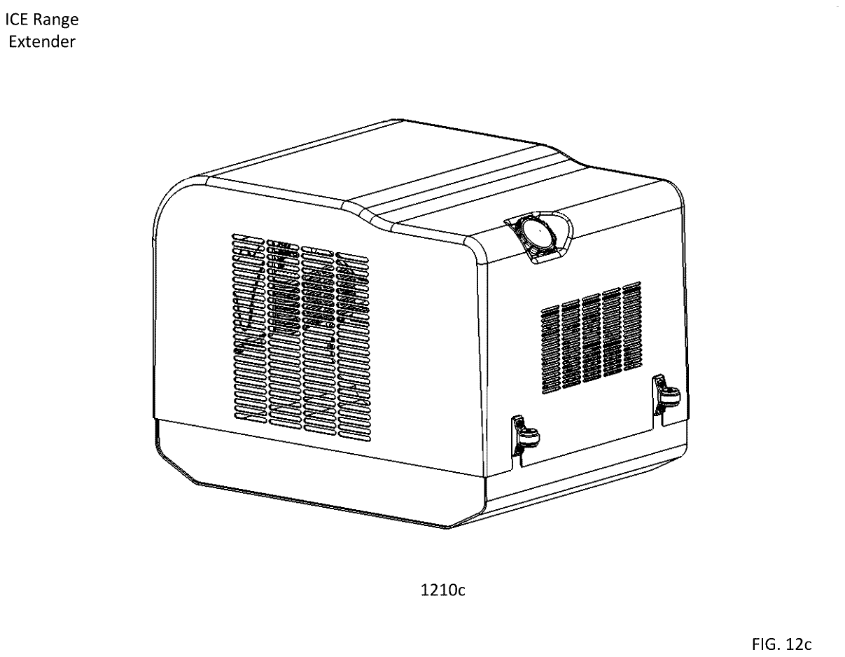

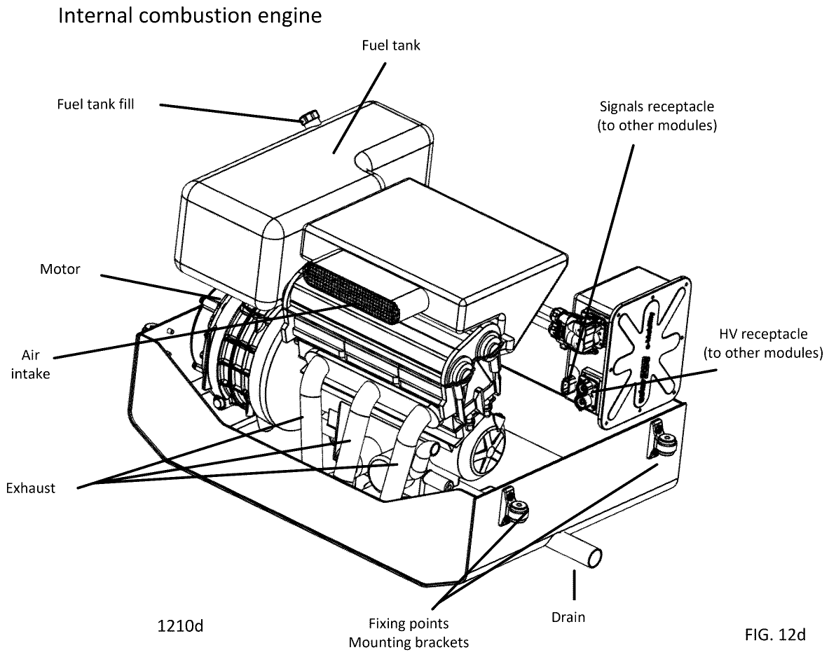

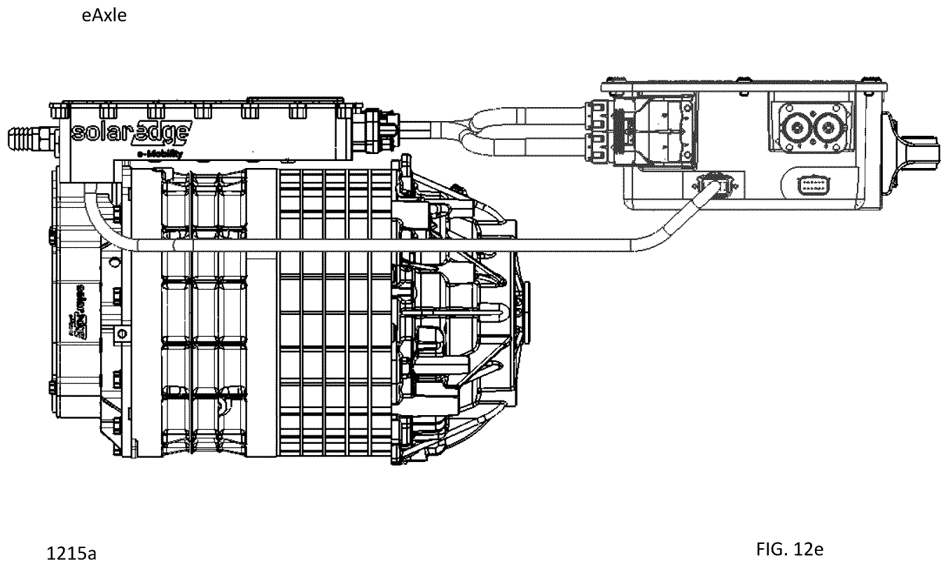

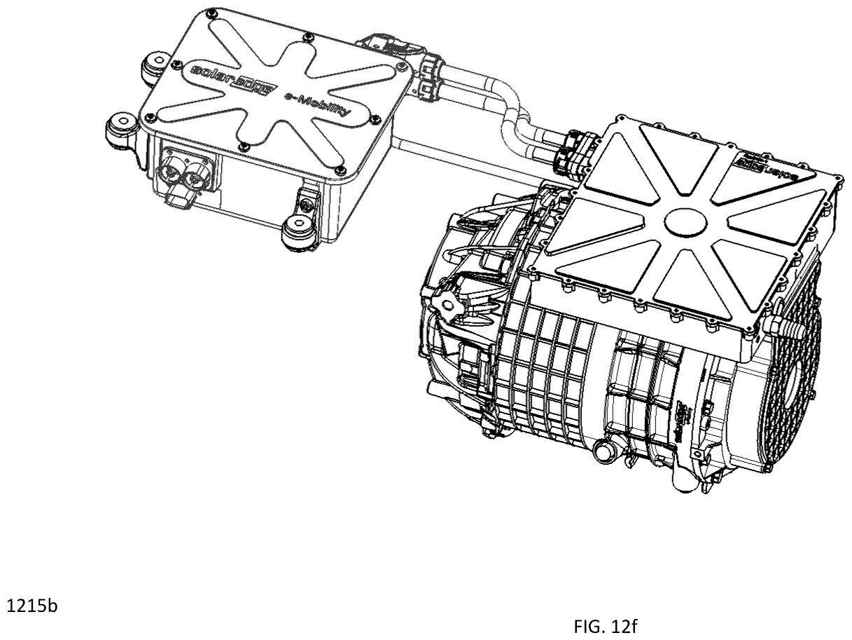

FIGS. 11 and 12 show examples of components that may be integrated into a configured section (e.g., module) of a configurable (e.g., modular) trailer. FIG. 11 shows a number of configured sections (e.g., modules) and/or external devices that may be integrated into a configurable (e.g., modular) trailer. A configurable (e.g., modular) trailer may comprise one or more different configured sections (e.g., modules). The different configured sections (e.g., modules) may be determined based on the needs of a particular configurable (e.g., modular) trailer. FIG. 11a shows a basic configured section. A configurable (e.g., modular) trailer may comprise a basic configured section (e.g., module) 1105a and 1105b. The basic configured section (e.g., module) 1105a and 1105b may comprise a single upstream power connector and a single downstream power connector with a single power conductor. The basic configured section (e.g., module) 1105a and 1105b may comprise a single upstream communication connector and a single downstream communication connector. The basic configured section (e.g., module) may comprise a controller, for example, that may monitor the configurable (e.g., modular) trailer performance, collect trailer data, and/or provide a communication hub for the configurable (e.g., modular) trailer.

A configurable (e.g., modular) trailer may provide greater functionality, for example, by configuring the configurable (e.g., modular) trailer with more configured sections (e.g., modules). FIG. 11b-11d show an energetic configured (e.g., module) section for a configurable (e.g., modular) trailer. A configurable (e.g., modular) trailer may be configured to provide power to the configurable (e.g., modular) trailer, and externally coupled devices, independently (e.g., without an outside source) for a period of time. The energetic configurable (e.g., modular) trailer may comprise a battery configured section (e.g., battery module, battery pack, etc.). The battery configured section (e.g., battery module, battery pack, etc.) may be charged by an external 3 phase AC power source. The external 3 phase AC power source may be electrically coupled to a power converter to convert the AC voltage to a DC voltage via a 3 phase AC power in charging socket. The battery configured section (e.g., battery module, battery pack, etc.) may be charged by a single phase AC source via a AC to DC power converter. The configurable (e.g., modular) trailer may be configured with a charge port signal receptacle to monitor the charging of a battery. The configurable (e.g., modular) trailer may be configured with output power connectors (e.g., a single phase AC power output connector, a 12 VDC power output, etc.) to power external devices. A configured section of a configurable (e.g., modular) trailer may be configured to be an energetic configured section 1110a-1110c. The energetic configured section may be configured with output power connectors.

A configurable (e.g., modular) trailer may be further configured so that the battery may be charged by one or more external solar cells. FIG. 11e shows an example of an advanced configurable section of a configurable trailer. The advanced configured section (e.g., module) 1115 may configured with a solar power receptacle that may be electrically coupled to the DC battery, for example, so that the battery may be charged via one or more external solar power cells. A configurable (e.g., modular) trailer may further be configured with a EV charging receptacle and/or a high voltage DC in.

FIG. 11f shows an example of a full equipped configured section (e.g., module) of a configurable (e.g., modular) trailer. A full equipped configured section (e.g., module) 1120a 1120g may be configured with an EV charging receptacle and/or a high voltage DC in connector that may electrically connect the DC battery to a DC source that may provide fast charging to the battery. A configured section (e.g., module) may be configured with air cooling devices. FIGS. 11f-11h shows an example of a full equipped configured section (e.g., module) 1120g configured with air fins to provide air cooling. A configured section (e.g., module) may be configured with a fluid cooling system. FIG. 11h shows an example of an advance or energetic configured section 1120i configured with tubing for fluid cooling.

A configurable (e.g., modular) trailer may be configured with ancillary devices. FIGS. 11i-11k show examples of ancillary devices that may be configured for a configurable section (e.g., module) of a configurable (e.g., modular) trailer. The ancillary devices and/or a communication hub may be Bluetooth enabled. An application for a smart device (e.g., a smart phone, a tablet, and/or a computer) may be designed and the configurable (e.g., modular) trailer configured so that details and/or controls of the ancillary device may be accessed via the smart device. The configurable (e.g., modular) trailer may be configured with a cooling 1125a and 1125c device may provide cooling to equipment that may require cooling (e.g., an ICE range extender, heat exchangers associated with power supplies and/or power sources, etc.). The cooling 1125a and 1125c device may be an air over tube style radiator, for example, that may use air flow across tubing to cool fluid flowing through the tubing. A cooling 1125a and 1125c device may be tubes filled with refrigerant. A cooling 1125a and 1125c device may be conductive cooling. A cooling 1125a and 1125c device may use thermoelectric cooling. The cooling 1125a and 1125c device may be configured with Bluetooth. Data from the cooling 1125a and 1125c device may be sent (e.g., transmitted) wirelessly to a second device configured with Bluetooth. The sent (e.g., transmitted) data may comprise coolant water inlet temperature to the cooling 1125a and 1125c device and/or coolant water output temperature from the cooling 1125a and 1125c device. The data may comprise ambient air temperature and/or temperature of the air exiting the coolant 1125a and 1125c device. The data may comprise coolant and/or air flowrate, coolant pressure, and/or coolant level (e.g., a coolant reservoir level). An application on a secondary device may use data sent (e.g., transmitted) from the cooling 1125a and 1125c device to analyze the cooling 1125a and 1125c device. Heat transfer values and/or efficiency of the cooling 1125a and 1125c device may be determined, for example, based on changes in temperatures and flowrates of the coolant and/or air. Coolant loss (e.g., from leaks in the cooling system) may be determined, for example, based on monitoring a coolant reservoir level.

A configurable (e.g., modular) trailer may be configured with a towing sensor 1130a and 1130c. FIG. 11i shows an example towing sensor 1130a and 1130c. The towing sensor may comprise one or more force sensors. The one or more force sensors of a towing sensor 1130a and 1130c may be configured uniformly around a tow hitch. The one or more force sensors may, alternatively, be configured at positions (e.g., position specific) on the tow hitch that may receive the highest force loads. The one or more force sensors may be configured as a combination of a uniform and/or a position specific. The uniform sensors may determine, for example, if tow forces shift because of changes in tow hitch pressure and/or changes in load placement. The towing sensor 1130a and 1130c may be configured with Bluetooth. The towing sensor 1130a and 1130c may send (e.g., transmit) force data of the one or more force sensors to a second device equipped with Bluetooth. The second device may have an application that may use the received data from the towing sensor to analyze the towing sensor and/or load changes. The application may provide a force map of the tow hitch, for example, based on the one or more force sensor values of the one or more force sensors. The application may determine a change in load placement, for example, if the force values on one side of the tow sensor decreases as the force values on a second side increase. A change in force values may indicate that loads on the trailer may have shifted and/or tire pressure of the configurable (e.g., modular) trailer has changed. A change in force values may indicate that the configurable (e.g., modular) trailer may have lost traction.

FIG. 11k shows an example of a DC/DC charger. A configurable (e.g., modular) trailer may be configured with a bi-directional DC/DC charger 1135. A bi-directional DC/DC charger 1135 may enable a battery pack of a configurable (e.g., modular) trailer to charge an external DC device (e.g., a battery of an EV) and/or the external DC device to charge a battery pack of the configurable (e.g., modular) trailer. The bi-directional DC/DC charger 1035 may be configured with one or more communication standards (e.g., ethernet, controller area network (CAN), Bluetooth, 3G/4G/5G, etc.). A transport (TP) layer may be a part of a CAN bus. The bi-directional DC/DC charger 1135 may be configured for different rated charging powers and currents (e.g., 6.6 kW at 26 Amps, 11.5 kW at 48 Amps, 22 kW at 36 Amps, etc.). The bi-directional DC/DC charger 1135 may comprise one or more sensors. The one or more sensors of a bi-directional DC/DC charger 1135 may comprise current sensors, voltage sensors, and/or power sensors. Voltage sensors may monitor both the input and output voltages, for example, to determine a power failure and/or a load disconnection. Current sensors may determine and/or open a contact to protect the bi-directional DC/DC charger, for example, if the input and/or output current goes outside a specified range. The sensor values may be sent (e.g., transmitted) via the one or more communication standards (e.g., Bluetooth) to a secondary device that may display the state of the bi-directional DC/DC charger 1135.

FIGS. 12a through 12e shows examples of additional configurable (e.g., modular) trailer equipment and/or devices. A configurable (e.g., modular) trailer, as described herein, may comprise one or more battery packs. FIG. 12a shows an example of a battery pack 1205a and 1205b. The battery packs 1205a and 1205b may be configured for different supply voltages and/or different milli-ampere hours (mAh). A configurable (e.g., modular) trailer may comprise a plurality of battery packs 1205a and 1205b with days of mAh, for example, if the configurable (e.g., modular) trailer is configured to provide power for an extended period of time away from a power grid. A battery pack 1205a and 1205b may be configured with one or more ports. The one or more ports may comprise a plurality of different power in options (e.g., different voltage inputs, different power type inputs, etc.). The one or more ports may comprise a plurality of different power out options. A battery pack 1205a and 1205b may be configured with one or more communication standards (e.g., ethernet, controller area network (CAN), Bluetooth, 3G/4G/5G, etc.). A battery pack 1205a and 1205b may be configured with one or more sensors (e.g., voltage, charging current, discharging current, etc.). Data from the one or more sensors may be sent (e.g., transmitted) via the one or more communication standards to a secondary device. The secondary device may have an application that may provide details of the battery pack 1205a and 1205b, for example, based on the data received from the one or more sensors. The application may use the data received to determine details of the battery pack 1205a and 1205b. The application may determine mAh remaining, for example, based on voltage and discharge current. The application may determine a change in charging and/or discharging, for example, based on changes to input and/or output voltages and/or charging and/or discharging currents.

A configurable (e.g., modular) trailer may be comprise an auxiliary power unit (APU). The APU may extend the working range of a configurable (e.g., modular) trailer, for example, by using additional energy sources that may complement and/or recharge a battery pack 1205a and 1205b. FIGS. 12b and 12c show an example of an internal combustion engine APU. An APU may be an internal combustion engine (ICE) range extender 1210a-1210d. The ICE range extender 1210a-1210d may generate electricity from gasoline using an ICE to power an AC and/or DC generator. A DC generator may be used to charge a battery pack 1210a 1210d and/or provide DC power. A DC generator may also be used as a DC motor. DC generators may be used in series. An AC generator may use an inverter to convert AC output to DC output to charge a battery pack 1210a-1210d and/or provide DC power in addition to the AC power. The ICE range extender may be configured with one or more communication standards (e.g., ethernet, controller area network (CAN), Bluetooth, 3G/4G/5G, etc.). The ICE range extender 1210a-1210d may comprise one or more sensors. The ICE range extender 1210a-1210d may comprise one or more voltage sensors, one or more current sensors, one or more power sensors, a sensor to determine rotational speed of the motor and/or generator, and/or a fuel level sensor. The ICE range extender 1210a-1210d may comprise a fuel tank level, for example, to determine the amount of fuel available. The ICE range extender 1210a 1210d may comprise voltage sensors to determine the load and/or the efficiency of the ICE range extender 1210a-1210d.

Additionally, or alternatively, an APU may be a fuel cell pack. A fuel cell pack may be a hydrogen fuel cell pack. A hydrogen fuel cell pack produces power using hydrogen. A hydrogen fuel cell pack may comprise a fuel cell stack, a fuel cell filler, and/or a fuel cell tank. A fuel cell stack comprises one or more membrane electrodes that create electricity by combining hydrogen with oxygen to produce water. A fuel cell filler for a hydrogen fuel cell pack may provide a means for hydrogen to fill a hydrogen fuel cell tank. The hydrogen fuel cell tank may provide a means to store hydrogen gas to be used by the fuel cell stack to produce electricity. A hydrogen fuel cell pack may further comprise an electric power controller system, a cooling system, and/or a transmission system. The electric power controller system may comprise a means to manage the flow of electrical energy generated in the fuel cell stack. The cooling system may be used to maintain the proper operating temperature range of the hydrogen fuel cell stack, an integrated electric motor, and/or other components associated with the fuel cell pack. The transmission system may be used to convert electrical power to mechanical power (e.g., an eAxle).

A configurable (e.g., modular) trailer may comprise an eAxle. FIGS. 12d and 12e show an example of an eAxle. An eAxle 1215a and 1215b may be integrated into an axle structure and propel a trailer using an electric motor as the primary power source. The eAxle may comprise a gearbox, a motor, and/or an inverter. An eAxle 1215a and 1215b may be configured for different powers (e.g., 50 kW to greater than 300 kW) and/or for different space considerations. An eAxle 1215a and 1215b may be used to recover rotational energy of an axle and convert it to electrical energy to charge a battery pack 1205a and 1205b. An eAxle 1215a and 1215b may be configured with one or more communication standards (e.g., ethernet, controller area network (CAN), Bluetooth, 3G/4G/5G, etc.). An eAxle 1215a and 1215b may be configured with one or more sensors (e.g., torque sensors, rotational sensors, voltage sensors, power sensors, etc.) to analyze operation of the eAxle 1215a and 1215b. The eAxle 1215a and 1215b may send (e.g., transmit) data acquired by the one or more sensors to a secondary device via the one or more communication standards. The secondary device may comprise an application that may display the received data. The application may analyze and determine the functionality of the eAxle 1215a and 1215b.

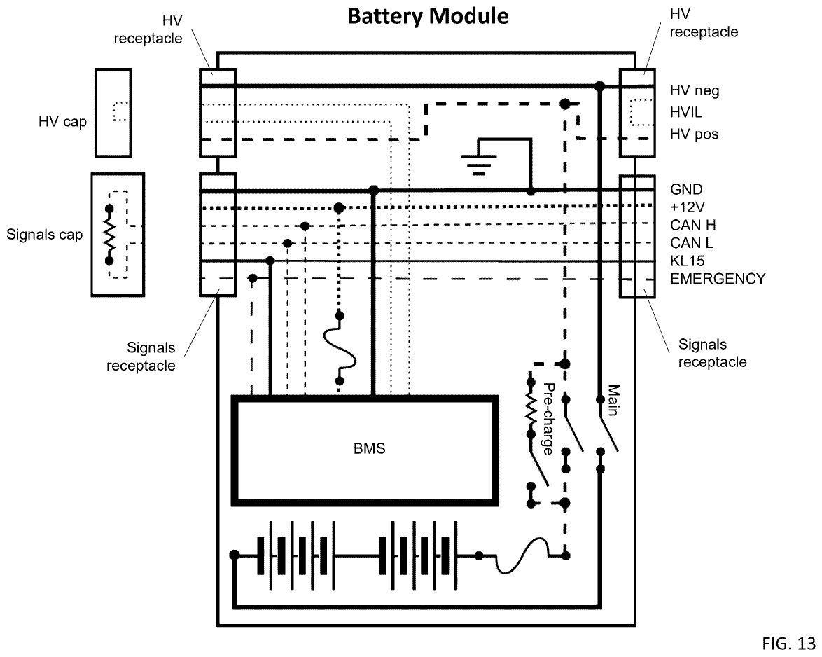

FIGS. 13-15 show example electrical diagrams of a configurable (e.g., modular) trailer. FIG. 13 shows an example of a circuit diagram for the battery configured section (e.g., battery module, battery pack, etc.). The battery configured section (e.g., battery module, battery pack, etc.) circuit diagram may comprise a main and a pre-charge switch, the battery management systems, 12 VCC power lines, CAN high and CAN low twisted pair, and the communication signals lines. A TP layer may be a part of a CAN bus. The battery circuit diagram also shows high voltage power conducting lines and the power conducting lines power connectors.

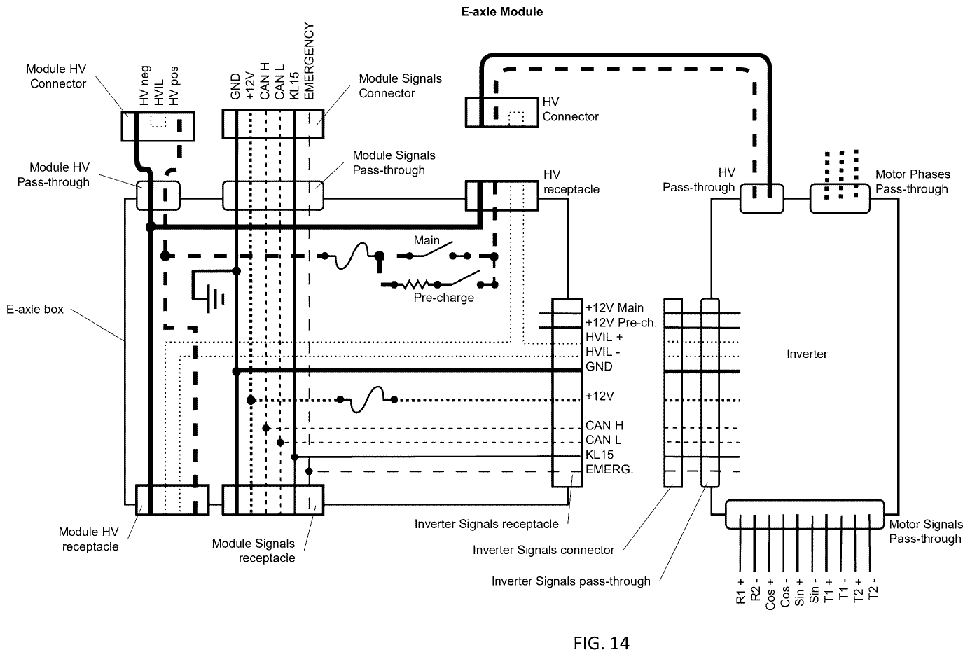

FIG. 14 shows an example of a circuit diagram for an eAxle box. The eAxle box circuit diagram shows a main and pre-charge switch, low voltage communication line wiring, high voltage power conducting line wiring and inverter to eAxle signals and power lines. The communication line wiring may comprise a 12 VCC line, a ground line, and/or CAN high and CAN low lines as a twisted pair. The power conducting lines may comprise a main and/or a pre-charge switch in parallel.

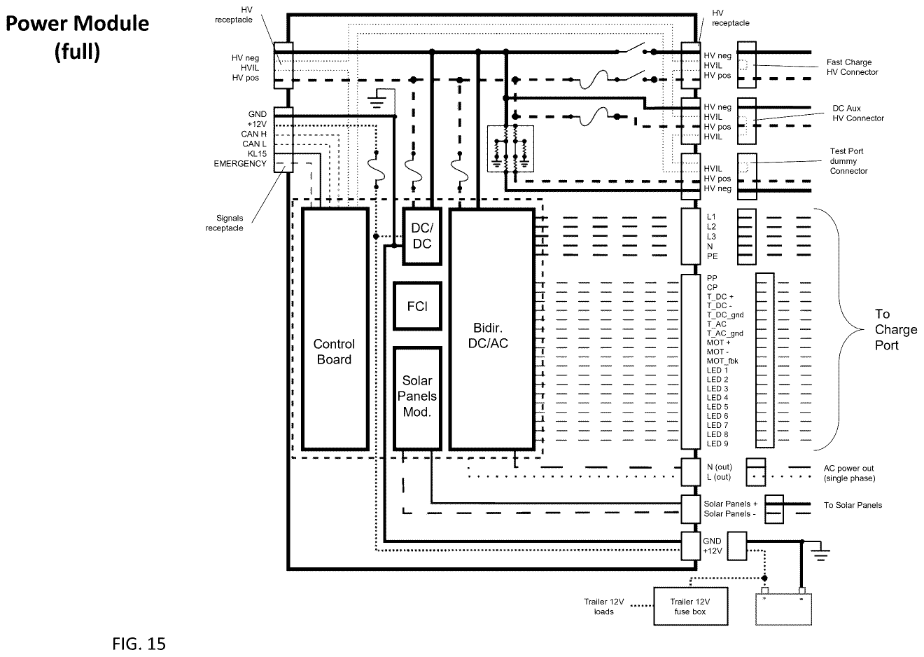

FIG. 15 shows an example of a power configured section (e.g., module) (e.g., a full power) circuit diagram. The power configured section (e.g., module) circuit diagram may comprise a low voltage communication line that may be electrically connected to a control board and a DC/DC power converter controller. The power configured section (e.g., module) circuit diagram may comprise a high voltage power conducting line that may be electrically connected to a bi-directional DC/AC converter. The high voltage power conducting lines may be electrically connected to one or more electrical connectors that may be used to connect to other power configured sections (e.g., modules), an eAxle box, and/or a battery configured section (e.g., battery module, battery pack, etc.).

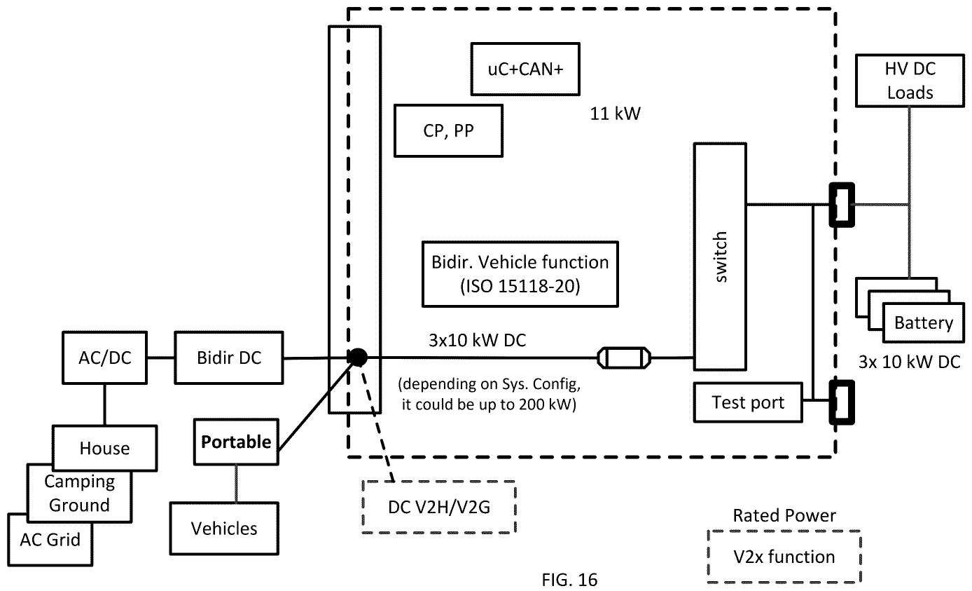

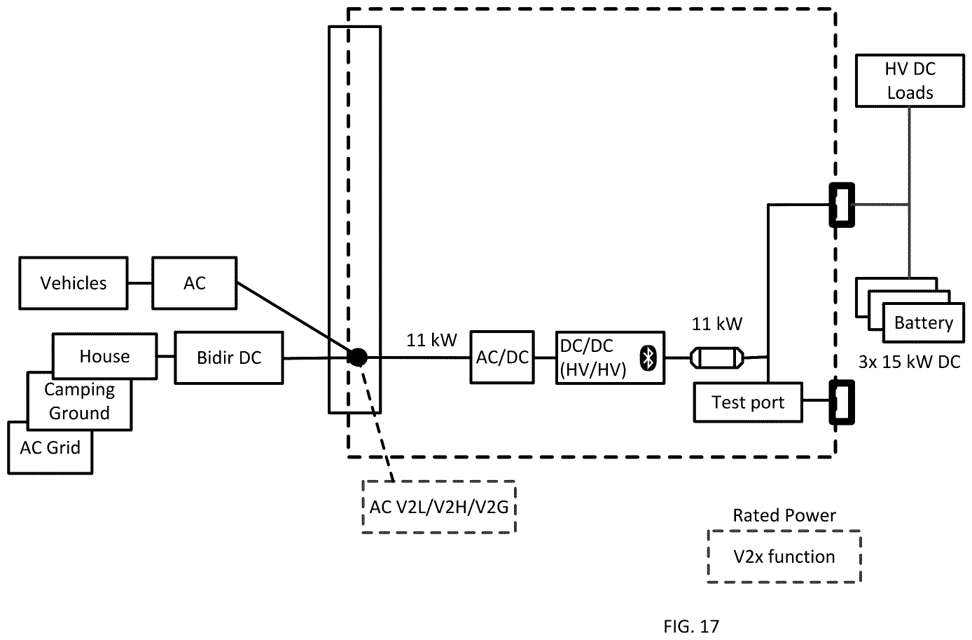

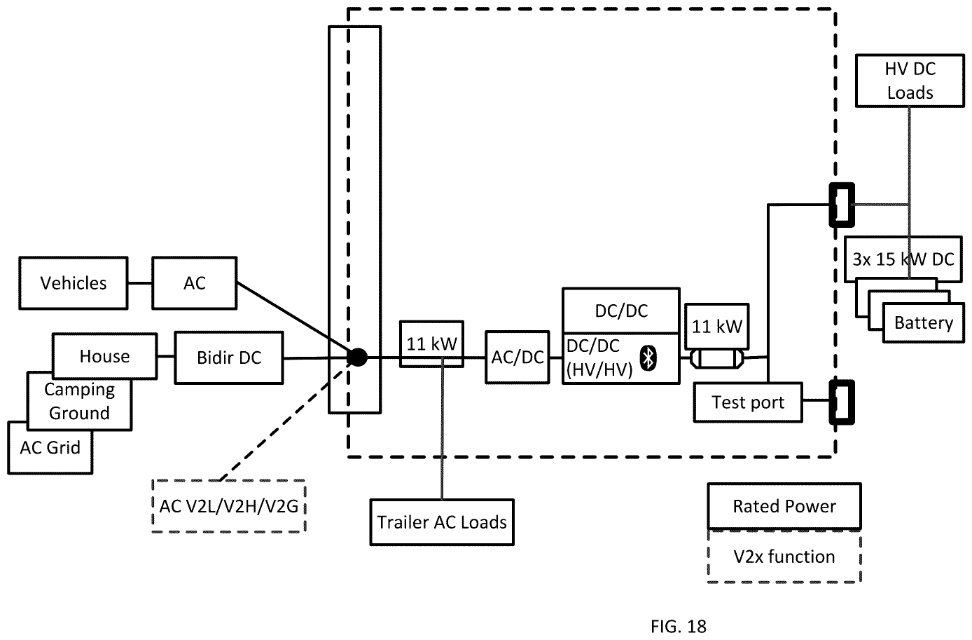

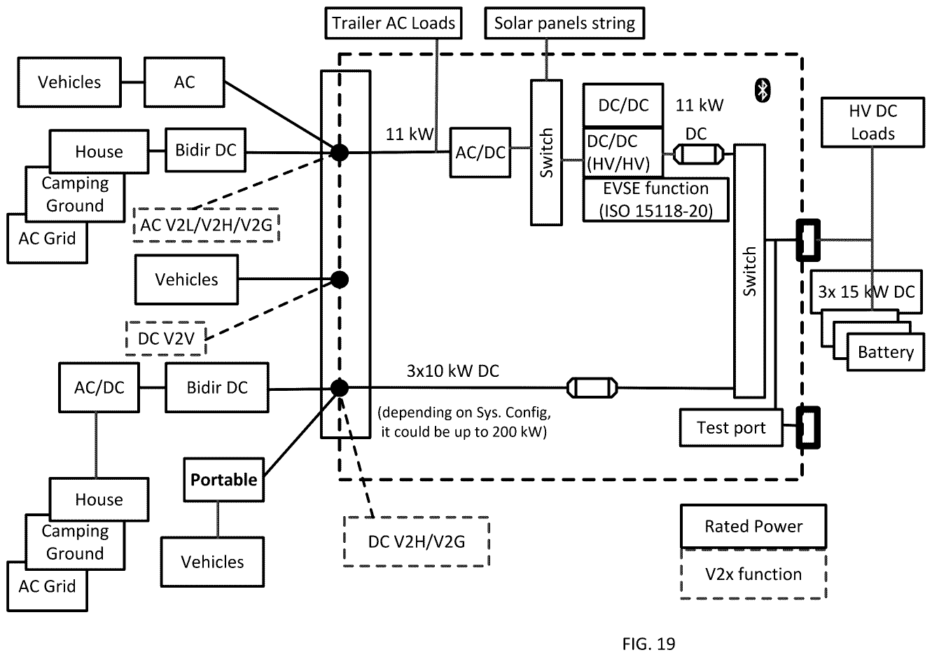

FIGS. 16-19 show example power layouts and buses of a configurable (e.g., modular) trailer and how equipment may be connected to the configurable (e.g., modular) trailer. FIG. 16 shows and example of a configurable (e.g., modular) trailer powering and/or powered by high-voltage (HV) DC loads and/or a plurality of batteries using a bi-directional vehicle charging function. FIG. 16 also shows how a configurable (e.g., modular) trailer may be powered by an external source (e.g., an AC grid, etc.) using an external AC to DC converter (e.g., an inverter) using bi-directional DC/DC charging. FIG. 17 shows an example of an external source supplying AC power to a configurable (e.g., modular) trailer and an AC/DC converter (e.g., inverter) internal to the configurable (e.g., modular) trailer suppling DC power to a bi-directional DC/DC charger to charge a battery configured section (e.g., battery module, battery pack, etc.), an external battery bank, and/or another HV DC load.

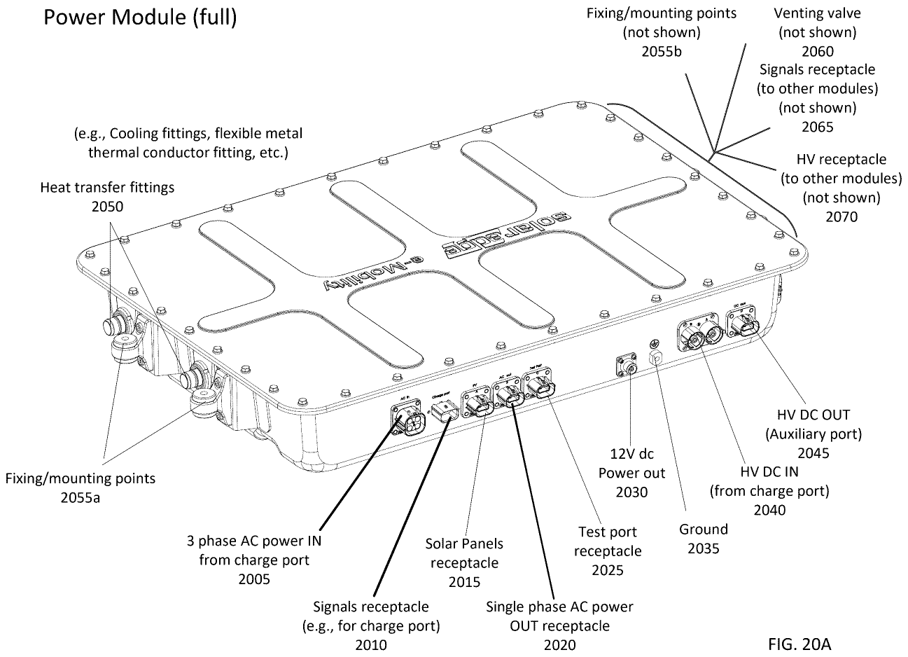

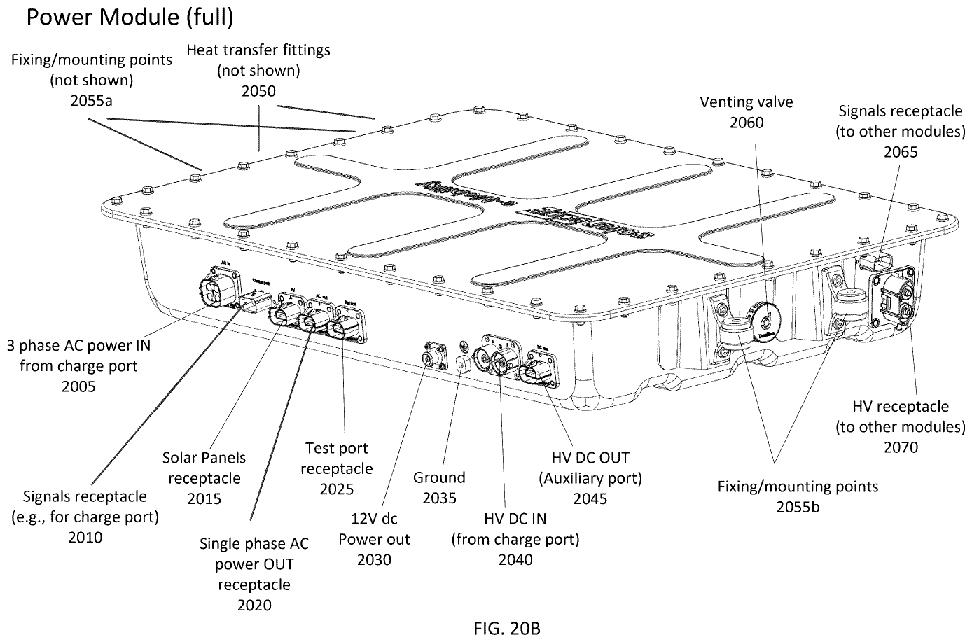

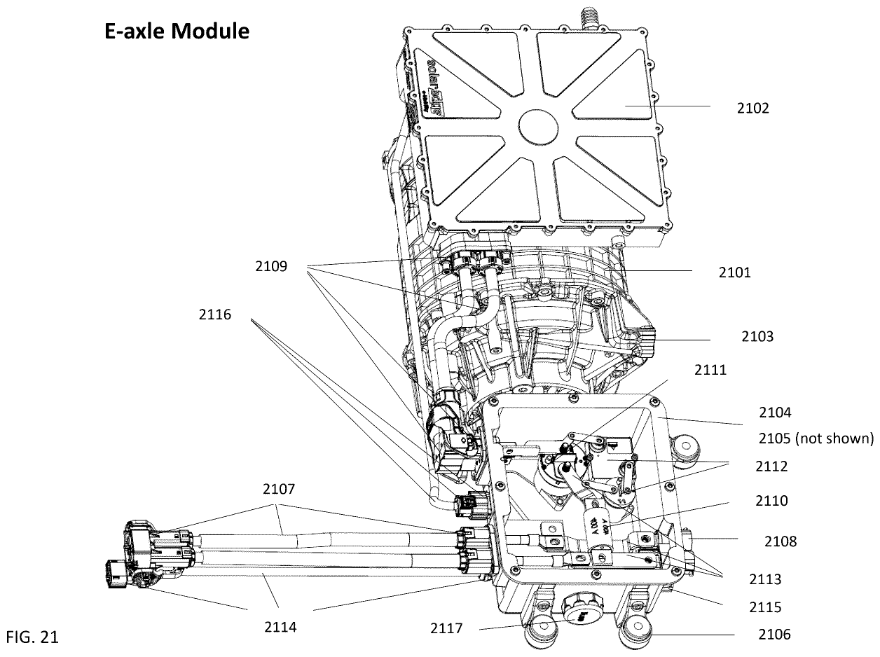

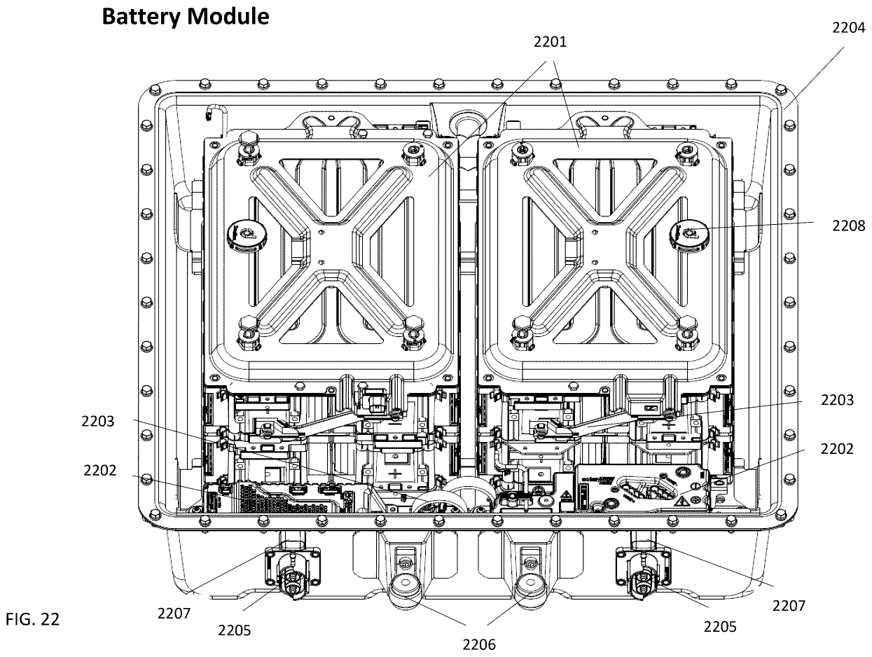

FIGS. 20A and 20B show an example of electrical, fluid, and mechanical connections of a configurable (e.g., modular) trailer. Connections may be integrated into a housing. Connections may comprise one or more electrical connections (e.g., HV DC IN, ground, 12V power out, signal receptacle for charging, solar panel connectors, single phase AC, test ports, HV DC auxiliary, three phase AC, etc.), one or more fluid connections (e.g., coolant couplers, cooling fittings, fittings, etc.), and/or one or more mechanical connections (e.g., fixing points). FIG. 20A shows connections that may comprise a configured section (e.g., module). Fluid connections of configured section (e.g., module) may comprise coolant couplers 2050 (e.g., cooling fittings, fittings, etc.). Mechanical connections of a configured section (e.g., module) may comprise one or more fixing points 2055a and 2055b (shown in FIG. 20B). The fixing points may comprise rubber mounting grommets. A configured section (e.g., module) may comprise a 3 phase AC power in 2005, a signals receptacle 2010 (e.g., a communication connector), a solar panels connector 2015 (e.g., solar panel receptacle), a single phase AC power out 2020, a test port connector 2025 (e.g., test port receptacle), a 12 VDC power out 2030, a ground connector 2030 (e.g., a ground terminal), a HV DC in 2040, and/or a HV DC out 2045.
FIG. 20B shows additional components that may comprise a configured section (e.g., module). A configured section (e.g., module) may further comprise a venting valve 2060, a HV connector 2070 (e.g., HV receptacle) to electrically connect power with other configured sections (e.g., modules), and/or a communications connector 2065 (e.g., a signals receptacle) to electrically connect communications with other configured sections (e.g., modules).
FIG. 21 shows an example of an eAxle assembly that may be used in a configurable (e.g., modular) trailer. The DC motor of an eAxle assembly may be rated for a power 50 kW, for example, based on the size of the configurable (e.g., modular) trailer and the weight the configurable (e.g., modular) trailer is expected to haul (e.g., carry, tow, etc.). The eAxle assembly may comprise an inverter. The inverter may be configured to receive an input of a known voltage and/or frequency and may control the output frequency and/or voltage. The eAxle assembly may also be configured with high voltage input cables and/or high voltage receptacles. The eAxle may comprise a motor 2102, an inverter 2102, a reducer 2103, a junction box enclosure 2104, and/or a junction box cover 2105. The eAxle may further comprise fixing points 2106 (e.g., rubber mountings), a main fuse 2110, a main contactor 2111, and/or a pre-charge circuit 2112. The eAxle may comprise a number of HV and LV components. The eAxle may comprise, for example, a HV out 2107. The HV out may comprise a pass-through for a cable and/or a connector to connect to an external cable. The cable may be shielded cable. The eAxle may comprise a HV in connector 2108 (e.g., HV in receptacle). The eAxle may comprise a HV inverter 2109. The HV inverter 2109 may comprise a pass through for a cable and/or a connector (e.g., a receptacle) to connect to an external cable. The cable may be shielded cable. The eAxle may comprise a LV out 2114. The LV out 2114 may comprise a cable gland. The LV out 2114 may comprise a connector that an external cable configured with a mating connector may connect to. The eAxle may comprise a LV in 2115. The LV in 2115 may comprise a receptacle. The eAxle may comprise an LV inverter 2116. The LV inverter 2116 may comprise a pass-through for a cable. The LV inverter 2116 may comprise a connector (e.g., a receptacle). The cable may be shielded. The eAxle may comprise a LV fuse fit 2117.
FIG. 22 shows an example of a battery configured section (e.g., battery module, battery pack, etc.) assembly that may be used in a configurable (e.g., modular) trailer. A battery configured section (e.g., battery module, battery pack, etc.) may comprise one or more battery half-packs 2201. The battery configured section (e.g., battery module, battery pack, etc.) may comprise one or more battery boards 2202, and/or one or more busbars and/or connections 2203. The battery configured section (e.g., battery module, battery pack, etc.) may comprise a case, a gasket, and/or a cover 2204. The battery configured section (e.g., battery module, battery pack, etc.) may comprise one or more HV connectors 2205 (e.g., HV receptacle) and one or more LV connectors 2207 (e.g., LV receptacle). The battery half pack may comprise one or more fixing points 2206 (e.g., rubber mounting) and one or more venting valves 2208.

An apparatus (e.g., a configurable trailer) may comprise a housing, an upstream power connector, a downstream power connector, a downstream communication connector, a switch, power conductors comprising power circuit nodes, a controller, and communication conductors electrically connecting the downstream communication connector and the controller. The power conductors may electrically connect the upstream power connector, the downstream power connector, and the switch to the power circuit nodes. An apparatus may further comprise a sensor coupled to a conductor between a power circuit node and a switch. The sensor may be a current sensor and/or a voltage sensor. A housing may be rated for ingress protection. The housing may be vehicle certified using International Electrotechnical Commission (IEC) number 60529 to a solids ingress protection (IP) rating of 6 and a liquids IP rating of at least 5. An apparatus may further comprise an upstream communication connector. Communication conductors may comprise communication circuit nodes. The communication conductors may electrically connect a downstream communication connector, the upstream communication connector, and a controller to the communication circuit nodes. An apparatus may further comprise a traction communication socket configured for connecting a traction motor inverter. The traction communication socket may be connected to communication circuit nodes. An apparatus may further comprise communication terminals, a communication cable comprising a first end and a second end, and a communication cable seal. Communication circuit nodes may be connected to the communication terminals. The communication terminals may be connected to the first end of the communication cable. The communication cable may exit a housing through a communication cable seal. The second end of the communication cable may be connected to an upstream communication connector. An apparatus may further comprise an external communication cable. An apparatus may further comprise a terminal, a power cable comprising a first end and a second end, and a power cable seal. A power circuit node may be connected to the terminal. The terminal may be connected to the first end of the power cable. The power cable may exit a housing through a power seal. The second end of the power cable may be connected to an upstream power connector. An apparatus may further comprise an external power cable. An apparatus may further comprise a ground terminal and/or socket on an exterior of a housing. The ground terminal and/or socket may be connected to the housing and/or an internal ground terminal of a circuit inside the housing. An upstream power connector may be integrated into a housing. The power circuit node may be connected to the upstream power connector. The upstream power connector may be configured to be connected to an external power cable. An upstream power connector may be configured to be able to couple to an electric vehicle (EV) charging plug. An apparatus may further comprise a power converter. An apparatus may further comprise a power socket that may be configured to be able to connect to an inverter of an electric motor. An apparatus may further comprise an inverter of an electric motor and/or a socket that may be configured to connect to the electric motor. An apparatus may further comprise a battery and/or a battery management system. An apparatus may further comprise a heat exchanger (e.g., a heatsink), coolant conduits, and/or coolant couplers (e.g., fittings). The coolant couplers (e.g., fittings) may be integrated into the housing. The coolant couplers (e.g., fittings) may be connected to the coolant conduits. The coolant conduits may be connected to the heat exchanger (e.g., heatsink). An apparatus may further comprise an EV charging plug. An apparatus may further comprise fixing points. An apparatus may further comprise a test socket. An apparatus may further comprise a low voltage power socket. A low voltage power socket may be configured for a voltage rating between 5 volts direct current (VDC) and/or 48 VDC. A low voltage power socket may also be configured for a voltage rating of 12 VDC. An apparatus may further comprise a high voltage auxiliary power socket. A high voltage auxiliary power socket may be configured for a voltage rating between 48 VDC and/or 2000 VDC. A high voltage auxiliary power socket may be configured for a voltage rating of 100-240 VDC, 400 VDC, and/or 800 VDC. The high voltage auxiliary power socket may be configured for a voltage rating greater than 100 VDC. The high voltage auxiliary power socket may be configured to connect to a heater and/or air conditioner of an electric vehicle. An apparatus may further comprise solar panel connectors. An apparatus may further comprise a precharge switch that may be connected in parallel to a switch. The precharge switch may comprise a resistor that may be connected in series with the precharge switch. A resistor, of an apparatus, may comprise a resistance value of at least 50 ohm and/or a power rating of at least 100 watts.

A system may comprise a plurality of apparatuses (e.g., configurable trailers). Each apparatus may comprise a housing, an upstream power connector, a downstream power connector, a downstream communication connector, a switch, power conductors comprising power circuit nodes, a controller, and communication conductors electrically connecting the downstream communication connector and the controller. The power conductors may electrically connect the upstream power connector, the downstream power connector, and/or the switch to the power circuit nodes. At least one of the plurality of apparatuses may comprise an upstream communication connector. The communication conductors may comprise communication circuit nodes. The communication conductors may electrically connect the downstream communication connector, the upstream communication connector, and/or the controller to the communication circuit nodes. A plurality of apparatuses, of a system, may be connected in a daisy chain configuration. An upstream power connector of one apparatus may be connected to a downstream power connector of another apparatus. A plurality of apparatuses, of a system, may be connected in a daisy chain configuration. An upstream communication connector of one apparatus may be connected to the downstream communication connector of another apparatus.

1. A configurable system for a trailer, wherein the configurable system comprises a plurality of modules, wherein each of the modules comprises:
a module housing;
a power conductor within the module housing and extending between power circuit nodes integrated with the module housing;
a communication conductor within the module housing and extending between communication circuit nodes integrated with the module housing; and
a controller in combination with both the power conductor and the communication conductor, wherein each of the power circuit nodes and the communication circuit nodes is connectable to at least one of: an external device of the trailer or a further one of the plurality of modules.

2. The configurable system of claim 1, wherein the power circuit nodes comprise an upstream power connector and a downstream power connector, each attached to the module housing, and the communication circuit nodes comprise an upstream communication connector and a downstream communication connector, each attached to the module housing.

3. The configurable system of claim 2, wherein:
a downstream power connector associated with a first module of the plurality of modules is connected to an upstream power connector associated with a second module of the plurality of modules.
a downstream communication connector associated with the first module of the plurality of modules is connected to an upstream communication connector associated with the second module of the plurality of modules.

4. The configurable system of claim 2, wherein:
an upstream power connector associated with a first module of the plurality of modules is connected to a power device of the trailer; and
an upstream communication connector associated with the first module of the plurality of modules is connected to a communication hub of the trailer.

5. The configurable system of claim 1, further comprising a switch in combination with the power conductor and the controller, wherein the controller is configured to disconnect an electric payload of the trailer, using the switch and in response to an abnormal condition, associated with the electric payload, from the power conductor.

6. The configurable system of claim 1, further comprising a current sensor or a voltage sensor coupled to at least one of the power circuit nodes.

7. The configurable system of claim 1, wherein the module housing comprises:
a plurality of external fixing points configured to attach the module housing to the trailer;
a plurality of internal fixing points configured to attach internal components to the module housing; and
the power circuit nodes comprising external power sockets on the module housing, wherein the power circuit nodes are configured to receive power from the trailer and provide power to downstream modules of the plurality of modules.

8. The configurable system of claim 1, wherein the power circuit nodes comprises a solar panel connector, wherein the solar panel connector is configured to receive electrical power from solar panels of the trailer.

9. The configurable system of claim 1, wherein at least one module of the plurality of modules comprises coolant conduits and fittings, wherein the fittings are integrated into the module housing, wherein the fittings are connected to the coolant conduits, and wherein the coolant conduits are connected to a heat exchanger.

10. The configurable system of claim 9, wherein the heat exchanger includes air fins connected to an outside surface of the at least one module.

11. The configurable system of claim 1, wherein at least one module of the plurality of modules comprises a traction invertor communication connector configured to connect a traction motor inverter of the trailer, wherein the traction inverter communication connector is configured to communicate with the traction motor inverter.

12. The configurable system of claim 1, wherein at least one module of the plurality of modules comprises a traction invertor electrically connected to the power conductor, and in communication with a traction motor of the trailer.

13. The configurable system of claim 1, wherein each of the plurality of modules is connected to an external device of the trailer, and the external device is independently selected from an inverter, an e-axle, a battery, a solar panel, or a cooling system.

14. The configurable system of claim 1, wherein at least one of the power circuit nodes is configured to be connected to an electric vehicle (EV) charging system.

15. The configurable system of claim 1, wherein the plurality of modules are connectable in a daisy chain configuration by connecting a downstream power circuit node of a first module of the plurality of modules to an upstream power circuit node of a second module of the plurality of modules.

16. The configurable system of claim 15, wherein each of the plurality of modules includes, as communication circuit nodes, an upstream communication connector and a downstream communication connector, and the plurality of the modules are connected in the daisy chain configuration by connecting the upstream communication connector of a first module of the plurality of modules to the downstream communication connector of the second module of the plurality of the plurality of modules.

17. The configurable system of claim 1, wherein the plurality of modules further comprises mounting fixtures for connecting to a frame of the trailer.

18. The configurable system of claim 1, wherein each of the plurality of modules comprises one or more of a different energy storage unit, a different power management system, a different cooling and/or heat exchange devices, an electric motor interface, or an electric motor inverter interface.

19. The configurable system of claim 1, wherein the plurality of modules comprises:
a first module including a high voltage electric vehicle charging connector;
a second module including a traction invertor electrically in communication with a traction motor of the trailer; and
a third module including a cooling and/or heat exchange apparatus.

20. A method of implementing the configurable system of claim 1, comprising:
determining the plurality of modules for the trailer; and
connecting the plurality of modules to each other and the trailer.
